(19) United States
(12) Patent Application Publication
(10) Pub. No.: US 2025/0391316 A1
(43) Pub. Date: Dec. 25, 2025

(54) METHOD FOR SETTING REFRESH RATE, DISPLAY DRIVER CHIP, AND ELECTRONIC DEVICE

(71) Applicant: HONOR DEVICE CO., LTD., Shenzhen (CN)

(72) Inventor: Yi Su, Shenzhen (CN)

(21) Appl. No.: 19/311,268

(22) Filed: Aug. 27, 2025

Related U.S. Application Data
(63) Continuation of application No. PCT/CN2023/136420, filed on Dec. 5, 2023.

(30) Foreign Application Priority Data
Mar. 2, 2023 (CN) 202310233234.X

(51) Int. Cl. G09G 3/20

(52) U.S. Cl. CPC G09G 3/2096; G09G 2300/026; G09G 2310/08; G09G 2330/021; G09G 2340/0435

(57) ABSTRACT

Embodiments of this application are applied to the field of electronic technologies, and provide a method for setting a refresh rate, a display driver chip, and an electronic device. The method includes: generating a divided clock signal corresponding to each display area based on a preset clock signal and a clock division parameter corresponding to each display area, and generating a second enable signal corresponding to each display area based on the divided clock signal corresponding to each display area and a corresponding first enable signal, where the second enable signal corresponding to each display area is configured for driving the display area corresponding to the second enable signal to perform display at a target refresh rate. Therefore, at least some of the display areas can perform display at different refresh rates, thereby reducing power consumption of an electronic device.

### CROSS-REFERENCE TO RELATED APPLICATIONS

This application is a continuation of International Application No. PCT/CN2023/136420, filed on Dec. 5, 2023, which claims priority to Chinese Patent Application No. 202310233234.X, filed on Mar. 2, 2023, both of which are incorporated herein by reference in their entireties.

### TECHNICAL FIELD

This application relates to the field of electronic technologies, and in particular, to a method for setting a refresh rate, a display driver chip, and an electronic device.

### BACKGROUND

With continuous development of electronic technologies, electronic devices such as mobile phones gradually become common tools in people's daily life and work. In some electronic devices, a display may be divided into at least two display areas, to independently display corresponding content through each display area.

However, when these electronic devices perform display through at least two display areas included in the electronic devices, these display areas all perform display at a same high refresh rate. This increases power consumption of the electronic devices.

### SUMMARY

Embodiments of this application provide a method for setting a refresh rate, a display driver chip, and an electronic device. At least some display areas are controlled to perform display at different target refresh rates, thereby reducing power consumption of an electronic device.

According to a first aspect, embodiments of this application provide a method for setting a refresh rate, applied to a display driver chip. The display driver chip is connected to a display. The display driver chip includes a timing controller. The display includes at least two display areas. The method includes: The timing controller generates a divided clock signal corresponding to each display area based on a preset clock signal and a clock division parameter corresponding to each display area. The timing controller generates a second enable signal corresponding to each display area based on the divided clock signal corresponding to each display area and a corresponding first enable signal. The second enable signal corresponding to each display area is configured for driving the display area corresponding to the second enable signal to perform display at a target refresh rate. Frequencies of the second enable signals corresponding to at least some of the display areas are different, and the target refresh rates corresponding to at least some of the display areas are also different.

In this way, for at least two display areas, in embodiments of this application, a second enable signal corresponding to each display area is generated, so that at least some of the display areas can perform display at different refresh rates. Therefore, a display area that requires a high refresh rate may be driven through a second enable signal having a high frequency, so that the display area may perform refresh and display at a high refresh rate. A display area that requires a low refresh rate may be driven through a second enable signal having a low frequency, so that the display area may perform refresh and display at a low refresh rate. Therefore, different refresh rates may be used to perform display for different display areas, thereby reducing power consumption of an electronic device.

In a possible implementation, the timing controller includes a clock divider module. That the timing controller generates a divided clock signal corresponding to each display area based on a preset clock signal and a clock division parameter corresponding to each display area includes: The clock divider module sequentially counts rising edges of the preset clock signal starting from a first count value to obtain a second count value corresponding to each display area. The clock divider module generates the divided clock signal corresponding to each display area based on the second count value corresponding to each display area and the preset clock signal. When a difference between the second count value corresponding to each display area and the first count value is equal to the clock division parameter corresponding to the display area, the clock divider module starts to count again from the first count value. In addition, when a reset signal in the timing controller is at a falling edge, the clock divider module starts to count again from the first count value. The clock division parameter is a positive integer. In this way, the clock divider module may sequentially count the rising edges of the preset clock signal and generate the divided clock signal based on the counted second count value and the preset clock signal, to subsequently generate the second enable signal corresponding to each display area. This manner of generating the divided clock signal is simple and relatively easy to implement.

In a possible implementation, that the clock divider module generates the divided clock signal corresponding to each display area based on the second count value corresponding to each display area and the preset clock signal includes: The clock divider module sets, for each display area, the preset clock signal when the second count value is equal to the first count value to a high level, and sets the preset clock signal when the second count value is not equal to the first count value to a low level, to obtain the divided clock signal. The first count value may be 0. In this way, an implementation of generating the divided clock signal by setting the preset clock signal when the second count value is equal to 0 to a high level and setting the preset clock signal when the second count value is not equal to 0 to a low level is provided.

In a possible implementation, that the clock divider module generates the divided clock signal corresponding to each display area based on the second count value corresponding to each display area and the preset clock signal includes: The clock divider module sets, for each display area, the preset clock signal when the second count value is equal to the first count value to a low level, and sets the preset clock signal when the second count value is not equal to the first count value to a high level, to obtain the divided clock signal. The first count value may be 0. In this way, another implementation of generating the divided clock signal by setting the preset clock signal when the second count value is equal to 0 to a low level and setting the preset clock signal when the second count value is not equal to 0 to a high level is provided.

In a possible implementation, the second enable signal corresponding to each display area is configured for generating an input signal of a first-level GOA unit corresponding to each display area. An output signal of a gate driver on array (GOA) unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is an N-type transistor. That the timing controller generates a second enable signal corresponding to each display area based on the divided clock signal corresponding to each display area and a corresponding first enable signal includes: The clock divider module performs an AND operation on the divided clock signal corresponding to each display area and the corresponding first enable signal, to obtain the second enable signal corresponding to each display area. In this way, when the preset clock signal when the second count value is equal to the first count value is set to a high level, and the preset clock signal when the second count value is not equal to the first count value is set to a low level, to obtain the divided clock signal, and the data write transistor is an N-type transistor, the corresponding second enable signal may be generated by performing an AND operation on the divided clock signal and the first enable signal, so that a manner of generating the second enable signal is simple and relatively easy to implement.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is a P-type transistor. That the timing controller generates a second enable signal corresponding to each display area based on the divided clock signal corresponding to each display area and a corresponding first enable signal includes: The clock divider module performs a NOT operation on the first enable signal corresponding to each display area, to obtain a third enable signal corresponding to each display area. The clock divider module performs a NAND operation on the divided clock signal corresponding to each display area and the corresponding third enable signal, to obtain the second enable signal corresponding to each display area. In this way, when the preset clock signal when the second count value is equal to the first count value is set to a high level, and the preset clock signal when the second count value is not equal to the first count value is set to a low level, to obtain the divided clock signal, and the data write transistor is a P-type transistor, the corresponding second enable signal may be generated by performing a NOT operation on the first enable signal to obtain the third enable signal and performing a NAND operation on the divided clock signal and the third enable signal, so that a manner of generating the second enable signal is simple and relatively easy to implement.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is an N-type transistor. That the timing controller generates a second enable signal corresponding to each display area based on the divided clock signal corresponding to each display area and a corresponding first enable signal includes: The clock divider module performs a NOT operation on the first enable signal corresponding to each display area, to obtain a third enable signal corresponding to each display area. The clock divider module performs a NOR operation on the divided clock signal corresponding to each display area and the corresponding third enable signal, to obtain the second enable signal corresponding to each display area. In this way, when the preset clock signal when the second count value is equal to the first count value is set to a low level, and the preset clock signal when the second count value is not equal to the first count value is set to a high level, to obtain the divided clock signal, and the data write transistor is an N-type transistor, the corresponding second enable signal may be generated by performing a NOT operation on the first enable signal to obtain the third enable signal and performing a NOR operation on the divided clock signal and the third enable signal, so that a manner of generating the second enable signal is simple and relatively easy to implement.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is a P-type transistor. That the timing controller generates a second enable signal corresponding to each display area based on the divided clock signal corresponding to each display area and a corresponding first enable signal includes: The clock divider module performs an OR operation on the divided clock signal corresponding to each display area and the corresponding first enable signal, to obtain the second enable signal corresponding to each display area. In this way, when the preset clock signal when the second count value is equal to the first count value is set to a low level, and the preset clock signal when the second count value is not equal to the first count value is set to a high level, to obtain the divided clock signal, and the data write transistor is a P-type transistor, the corresponding second enable signal may be generated by performing an OR operation on the divided clock signal and the first enable signal, so that a manner of generating the second enable signal is simple and relatively easy to implement.

In a possible implementation, the timing controller further includes a timing generation module. The clock divider module includes a clock divider submodule corresponding to each display area. Each clock divider submodule includes an up counter and a clock divider. Before that the clock divider module sequentially counts rising edges of the preset clock signal starting from a first count value to obtain a second count value corresponding to each display area, the method further includes: The timing generation module outputs the preset clock signal and the reset signal to each up counter. That the clock divider module sequentially counts rising edges of the preset clock signal starting from a first count value to obtain a second count value corresponding to each display area includes: The up counter sequentially counts the rising edges of the preset clock signal starting from the first count value, to obtain the second count value. That the clock divider module generates the divided clock signal corresponding to each display area based on the second count value corresponding to each display area and the preset clock signal includes: The clock divider generates the divided clock signal based on the second count value and the preset clock signal. When the difference between the second count value corresponding to each display area and the first count value is equal to the clock division parameter corresponding to the display area, the up counter starts to count again from the first count value. In addition, when the reset signal is at the falling edge, the up counter starts to count again from the first count value. In this way, the divided clock signal corresponding to each display area may be generated through the coordination of the up counter and the clock divider.

In a possible implementation, the timing controller further includes a GOA control module. Each clock divider submodule further includes a logic operation unit. Before that the timing controller generates a second enable signal corresponding to each display area based on the divided clock signal corresponding to each display area and a corresponding first enable signal, the method further includes: The GOA control module outputs, to each logic operation unit, the first enable signal corresponding to the logic operation unit. The clock divider outputs the divided clock signal to the logic operation unit corresponding to the clock divider. That the timing controller generates a second enable signal corresponding to each display area based on the divided clock signal corresponding to each display area and a corresponding first enable signal includes: The logic operation unit generates the second enable signal based on the divided clock signal and the first enable signal. In this way, the second enable signal is generated through the logic operation unit.

In a possible implementation, the display driver chip further includes an analog circuit module. After that the timing controller generates a second enable signal corresponding to each display area based on the divided clock signal corresponding to each display area and a corresponding first enable signal, the method further includes: The analog circuit module converts the second enable signal into a fourth enable signal, to output the fourth enable signal to the display. The fourth enable signal corresponding to each display area is an input signal of a first-level GOA unit corresponding to each display area. The second enable signal is a digital signal. The fourth enable signal is an analog signal. A level of the fourth enable signal is greater than a level of the second enable signal. Because the second enable signal generated by the timing controller is a digital signal, and a GOA circuit in the display requires an analog signal whose level meets a requirement, the analog circuit module is further disposed between the timing controller and the display, and the second enable signal is converted into the fourth enable signal through the analog circuit module, to provide the GOA circuit in the display with the fourth enable signal that meets a requirement.

In a possible implementation, the display driver chip further includes a signal receiving and interpretation module, a core controller, a memory controller, and a frame buffer. Before that the timing controller generates a divided clock signal corresponding to each display area based on a preset clock signal and a clock division parameter corresponding to each display area, the method further includes: The signal receiving and interpretation module parses a data packet sent by a processor, to obtain display data corresponding to each display area and the target refresh rate corresponding to each display area. The signal receiving and interpretation module sends the display data corresponding to each display area to the memory controller, and sends the target refresh rate corresponding to each display area to the core controller. The memory controller stores the display data corresponding to each display area in the frame buffer. The core controller sends the target refresh rate corresponding to each display area to the timing controller. The timing controller generates the clock division parameter corresponding to each display area based on the target refresh rate corresponding to each display area.

In a possible implementation, the display is a foldable screen or a non-foldable screen.

According to a second aspect, embodiments of this application provide a display driver chip. The display driver chip is connected to a display. The display driver chip includes a timing controller. The display includes at least two display areas. The timing controller is configured to: generate a divided clock signal corresponding to each display area based on a preset clock signal and a clock division parameter corresponding to each display area; and generate a second enable signal corresponding to each display area based on the divided clock signal corresponding to each display area and a corresponding first enable signal. The second enable signal corresponding to each display area is configured for driving the display area corresponding to the second enable signal to perform display at a target refresh rate. Frequencies of the second enable signals corresponding to at least some of the display areas are different, and the target refresh rates corresponding to at least some of the display areas are also different.

In a possible implementation, the timing controller includes a clock divider module. The clock divider module is configured to: sequentially count rising edges of the preset clock signal starting from a first count value to obtain a second count value corresponding to each display area; and generate the divided clock signal corresponding to each display area based on the second count value corresponding to each display area and the preset clock signal. When a difference between the second count value corresponding to each display area and the first count value is equal to the clock division parameter corresponding to the display area, the clock divider module starts to count again from the first count value. In addition, when a reset signal in the timing controller is at a falling edge, the clock divider module starts to count again from the first count value. The clock division parameter is a positive integer.

In a possible implementation, the clock divider module is further configured to: set, for each display area, the preset clock signal when the second count value is equal to the first count value to a high level, and set the preset clock signal when the second count value is not equal to the first count value to a low level, to obtain the divided clock signal.

In a possible implementation, the clock divider module is further configured to: set, for each display area, the preset clock signal when the second count value is equal to the first count value to a low level, and set the preset clock signal when the second count value is not equal to the first count value to a high level, to obtain the divided clock signal.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is an N-type transistor. The clock divider module is further configured to: perform an AND operation on the divided clock signal corresponding to each display area and the corresponding first enable signal, to obtain the second enable signal corresponding to each display area.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is a P-type transistor. The clock divider module is further configured to: perform a NOT operation on the first enable signal corresponding to each display area, to obtain a third enable signal corresponding to each display area; and perform a NAND operation on the divided clock signal corresponding to each display area and the corresponding third enable signal, to obtain the second enable signal corresponding to each display area.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is an N-type transistor. The clock divider module is further configured to: perform a NOT operation on the first enable signal corresponding to each display area, to obtain a third enable signal corresponding to each display area; and perform a NOR operation on the divided clock signal corresponding to each display area and the corresponding third enable signal, to obtain the second enable signal corresponding to each display area.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is a P-type transistor. The clock divider module is further configured to: perform an OR operation on the divided clock signal corresponding to each display area and the corresponding first enable signal, to obtain the second enable signal corresponding to each display area.

In a possible implementation, the timing controller further includes a timing generation module. The clock divider module includes a clock divider submodule corresponding to each display area. Each clock divider submodule includes an up counter and a clock divider. The timing generation module is configured to output the preset clock signal and the reset signal to each up counter. The up counter is configured to sequentially count the rising edges of the preset clock signal starting from the first count value, to obtain the second count value. The clock divider is configured to generate the divided clock signal based on the second count value and the preset clock signal. When the difference between the second count value corresponding to each display area and the first count value is equal to the clock division parameter corresponding to the display area, the up counter starts to count again from the first count value. In addition, when the reset signal is at the falling edge, the up counter starts to count again from the first count value.

In a possible implementation, the timing controller further includes a GOA control module. Each clock divider submodule further includes a logic operation unit. The GOA control module is configured to output, to each logic operation unit, the first enable signal corresponding to the logic operation unit. The clock divider is further configured to output the divided clock signal to the logic operation unit corresponding to the clock divider. The logic operation unit is configured to generate the second enable signal based on the divided clock signal and the first enable signal.

In a possible implementation, the display driver chip further includes an analog circuit module. The analog circuit module is configured to convert the second enable signal into a fourth enable signal, to output the fourth enable signal to the display. The fourth enable signal corresponding to each display area is an input signal of a first-level GOA unit corresponding to each display area. The second enable signal is a digital signal. The fourth enable signal is an analog signal. A level of the fourth enable signal is greater than a level of the second enable signal.

In a possible implementation, the display driver chip further includes a signal receiving and interpretation module, a core controller, a memory controller, and a frame buffer. The signal receiving and interpretation module is configured to parse a data packet sent by a processor, to obtain display data corresponding to each display area and the target refresh rate corresponding to each display area. The signal receiving and interpretation module is further configured to send the display data corresponding to each display area to the memory controller, and sending the target refresh rate corresponding to each display area to the core controller. The memory controller is configured to store the display data corresponding to each display area in the frame buffer. The core controller is configured to send the target refresh rate corresponding to each display area to the timing controller. The timing controller is configured to generate the clock division parameter corresponding to each display area based on the target refresh rate corresponding to each display area.

In a possible implementation, the display is a foldable screen or a non-foldable screen.

According to a third aspect, embodiments of this application provide an electronic device, including a processor, a display, and the foregoing display driver chip, where the processor is connected to the display driver chip, and the display driver chip is further connected to the display.

Effects of various possible implementations of the second aspect and the third aspect are similar to effects of the first aspect and the possible designs of the first aspect, and details are not described herein again.

### BRIEF DESCRIPTION OF DRAWINGS

FIG. 1 is a schematic diagram of a structure of an electronic device according to an embodiment of this application;

FIG. 2 is a schematic diagram of a structure of another electronic device according to an embodiment of this application;

FIG. 3 is a schematic diagram of a structure of still another electronic device according to an embodiment of this application;

FIG. 4 is a schematic diagram of a structure of a display driver chip according to an embodiment of this application;

FIG. 5 is a schematic flowchart of a method for setting a refresh rate according to an embodiment of this application;

FIG. 6 is a schematic diagram of first clock division logic for generating a plurality of second enable signals with different frequencies according to an embodiment of this application;

FIG. 7 is a schematic diagram of second clock division logic for generating a plurality of second enable signals with different frequencies according to an embodiment of this application;

FIG. 8 is a schematic diagram of third clock division logic for generating a plurality of second enable signals with different frequencies according to an embodiment of this application;

FIG. 9 is a schematic diagram of fourth clock division logic for generating a plurality of second enable signals with different frequencies according to an embodiment of this application;

FIG. 10 is a schematic diagram of a structure of a plurality of cascaded GOA units according to an embodiment of this application; and

FIG. 11 is a circuit diagram of a pixel driver circuit according to an embodiment of this application.

### DESCRIPTION OF EMBODIMENTS

To clearly describe the technical solutions in embodiments of this application, words such as “first” and “second” are used in embodiments of this application to distinguish between same items or similar items that have basically a same function or purpose. For example, a first chip and a second chip are merely used to distinguish different chips, and are not intended to limit a sequence thereof. A person skilled in the art may understand that the words such as “first” and “second” do not limit a quantity or an execution sequence, and the words such as “first” and “second” do not define a definite difference.

It should be noted that in the embodiments of this application, words such as “example” or “for example” are used to represent giving an example, an illustration, or a description. Any embodiment or design solution described as “example” or “for example” in this application should not be construed as preferred or advantageous over other embodiments or design solutions. Exactly, use of the term such as “exemplary” or “for example” is intended to present a related concept in a specific manner.

In the embodiments of this application, “at least one” means one or more, and “a plurality of” means two or more. The term “and/or” is an association relationship for describing associated objects, and may indicate that three relationships may exist. For example, A and/or B may indicate the following cases: Only A exists, both A and B exist, and only B exits, where A and B may be singular or plural. The character “/” usually indicates an “or” relationship between the associated objects. “At least one of the following items (pieces)” or a similar expression thereof indicates any combination of these items, including a single item (piece) or any combination of a plurality of items (pieces). For example, at least one of a, b, or c may represent a, b, c, a and b, a and c, b and c, or a, b, and c, where a, b, and c may be singular or plural.

In some electronic devices, a display included in the electronic devices may be a foldable screen, and the foldable screen may be unfolded or folded along a folding shaft. The foldable screen may include at least two display areas, and each display area may independently display corresponding content.

It should be noted that the foldable screen in embodiments of this application may be a flexible foldable screen. At least two screens formed after the flexible foldable screen is folded are a complete screen with an integral structure. The at least two screens are only formed through folding, and each screen is used as one display area. In this case, an area in which a folding shaft is located may be used for display, and the area in which the folding shaft is located and areas located on two sides of the folding shaft form one complete screen. Alternatively, the foldable screen in embodiments of this application may include at least two screens, each screen is disposed separately, and each screen is used as one display area. These screens may be connected in sequence by a folding shaft. In this case, an area in which the folding shaft is located is not used for display, and the foldable screen is separated by the folding shaft into at least two display areas independent of each other.

In addition, the foldable screen in embodiments of this application may be folded to form two screens, or may be folded to form three or more screens. A specific form and a folding manner of the foldable screen are not limited in embodiments of this application.

In some other electronic devices, a display included in the electronic devices may be a non-foldable screen. In an electronic device having a non-foldable screen, a display of the electronic device may also be divided into at least two display areas by using a split screen technology, to independently display corresponding content through each display area.

It is mainly described that the non-foldable screen in embodiments of this application includes only one screen, and the screen is divided into at least two display areas by using a split screen technology, to display different content. In other words, interfaces of a plurality of different applications are displayed on the same screen.

In the related art, regardless of whether at least two display areas are formed by folding a foldable screen to perform display or a screen of a non-foldable screen is divided into at least two display areas by using a split screen technology to perform display, in the at least two display areas, when a high refresh rate is required for one or more of the display areas, all these display areas perform refresh and display at a same high refresh rate. In this case, a display area that does not require a high refresh rate is also displayed at the high refresh rate. Consequently, power consumption of an electronic device increases.

Based on this, embodiments of this application provide a method for setting a refresh rate, a display driver chip, and an electronic device. The display driver chip includes a timing controller. The timing controller generates a divided clock signal corresponding to each display area based on a preset clock signal and a clock division parameter corresponding to each display area. The timing controller generates a second enable signal corresponding to each display area based on the divided clock signal corresponding to each display area and a corresponding first enable signal. The second enable signal corresponding to each display area is configured for driving the display area corresponding to the second enable signal to perform display at a target refresh rate. Frequencies of the second enable signals corresponding to at least some of the display areas are different, and the target refresh rates corresponding to at least some of the display areas are also different.

Therefore, for at least two display areas, in embodiments of this application, a second enable signal corresponding to each display area is generated, so that at least some of the display areas can perform display at different refresh rates. In this way, a display area that requires a high refresh rate may be driven through a second enable signal having a high frequency, so that the display area may perform refresh and display at a high refresh rate. A display area that requires a low refresh rate may be driven through a second enable signal having a low frequency, so that the display area may perform refresh and display at a low refresh rate. Therefore, different refresh rates may be used to perform display for different display areas, thereby reducing power consumption of an electronic device.

The electronic device provided in embodiments of this application may be an electronic device, for example, a mobile phone, a notebook computer, a tablet computer (Pad), a wearable device (for example, a smartwatch or a smart band), an in-vehicle device, an ultra-mobile personal computer (ultra-mobile personal computer, UMPC), a netbook, or a personal digital assistant (PDA). Embodiments of this application impose no limitation on a specific technology and a specific device form used by the electronic device.

For ease of understanding, a specific concept of a refresh rate in embodiments of this application is provided below by way of example. The refresh rate may also be referred to as a screen refresh rate, which is a quantity of times that an image on a screen is refreshed per second, and a unit of the refresh rate is Hz.

The following exemplarily describes embodiments of this application by using an example in which an electronic device is a mobile phone and a display in the mobile phone is a foldable screen. At least two display areas included in the electronic device perform display at different refresh rates.

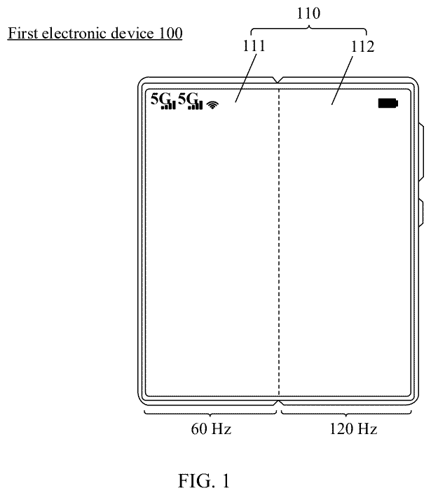

As shown in FIG. 1, a first electronic device 100 is a dual-fold electronic device, and includes a first display 110. The first display 110 includes a first screen 111 and a second screen 112. The first screen 111 and the second screen 112 may be folded or unfolded along a folding shaft. The first screen 111 may be used as one display area, and the second screen 112 may also be used as one display area. In other words, the first electronic device 100 shown in FIG. 1 includes two display areas.

The two display areas may simultaneously display different content, and when the two display areas display corresponding content, refresh rates corresponding to the two display areas are different. For example, a refresh rate of the first screen 111 may be 60 Hz, and a refresh rate of the second screen 112 may be 120 Hz. In other words, the refresh rate of the first screen 111 is different from the refresh rate of the second screen 112.

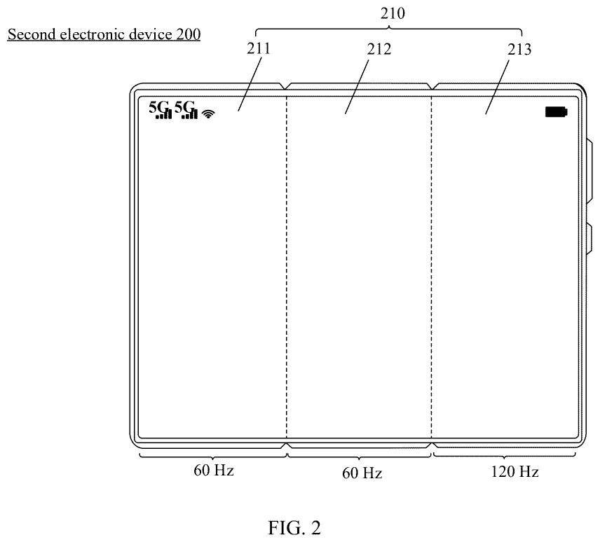

As shown in FIG. 2, a second electronic device 200 is a tri-fold electronic device, and includes a second display 210. The second display 210 includes a third screen 211, a fourth screen 212, and a fifth screen 213. The third screen 211 and the fourth screen 212 may be folded or unfolded along one folding shaft, and the fourth screen 212 and the fifth screen 213 may be folded or unfolded along another folding shaft. The third screen 211 may be used as one display area, the fourth screen 212 may also be used as one display area, and the fifth screen 213 may also be used as one display area. In other words, the second electronic device 200 shown in FIG. 2 includes three display areas.

The three display areas may simultaneously display different content, and when the three display areas display corresponding content, refresh rates corresponding to at least some of the display areas are different. For example, a refresh rate of the third screen 211 may be 60 Hz, a refresh rate of the fourth screen 212 may be 60 Hz, and a refresh rate of the fifth screen 213 may be 120 Hz. In other words, the refresh rate of the third screen 211 is different from the refresh rate of the fifth screen 213, and the refresh rate of the fourth screen 212 is also different from the refresh rate of the fifth screen 213.

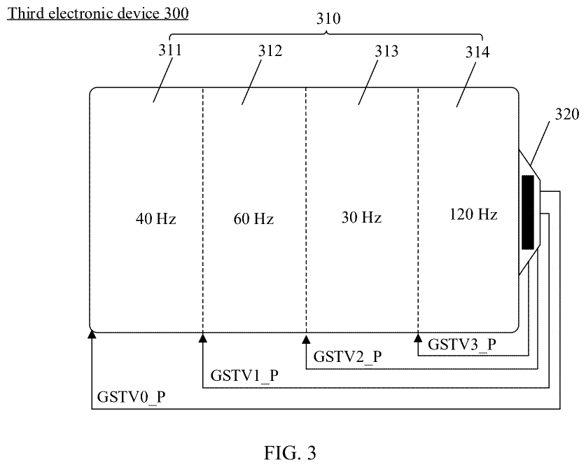

As shown in FIG. 3, a third electronic device 300 may be a quad-fold electronic device, and includes a third display 310. The third display 310 includes a sixth screen 311, a seventh screen 312, an eighth screen 313, and a ninth screen 314. The sixth screen 311 and the seventh screen 312 may be folded or unfolded along one of folding shafts, the seventh screen 312 and the eighth screen 313 may be folded or unfolded along another folding shaft, and the eighth screen 313 and the ninth screen 314 may be folded or unfolded along still another folding shaft. The sixth screen 311 may be used as one display area, the seventh screen 312 may also be used as one display area, the eighth screen 313 may also be used as one display area, and the ninth screen 314 may also be used as one display area. In other words, the third electronic device 300 shown in FIG. 3 includes four display areas.

The four display areas may simultaneously display different content, and when the four display areas display corresponding content, refresh rates corresponding to at least some of the display areas are different. For example, a refresh rate of the sixth screen 311 may be 40 Hz, a refresh rate of the seventh screen 312 may be 60 Hz, a refresh rate of the eighth screen 313 may be 30 Hz, and a refresh rate of the ninth screen 314 may be 120 Hz. The refresh rates of any two of the sixth screen 311, the seventh screen 312, the eighth screen 313, and the ninth screen 314 are different.

In addition, the third electronic device 300 further includes a display driver chip 320. The display driver chip 320 may be located on a lateral side of the third display 310 and is connected to the third display 310. For example, the display driver chip 320 is located on a side of the ninth screen 314 away from the eighth screen 313.

The display driver chip 320 may generate a clock division parameter corresponding to each display area based on a data packet sent by a processor, generate a divided clock signal corresponding to each display area based on the preset clock signal and a clock division parameter corresponding to each display area, and then generate a second enable signal corresponding to each display area based on the divided clock signal corresponding to each display area and a corresponding first enable signal. The display driver chip 320 may further convert the second enable signal into a fourth enable signal, and output the fourth enable signal to the third display 310.

For example, the fourth enable signal outputted by the display driver chip 320 to the sixth screen 311 is GSTV0_P, and the fourth enable signal GSTV0_P corresponding to the sixth screen 311 is configured for driving the sixth screen 311 to perform display at a target refresh rate of 40 Hz. The fourth enable signal outputted by the display driver chip 320 to the seventh screen 312 is GSTV1_P, and the fourth enable signal GSTV1_P corresponding to the seventh screen 312 is configured for driving the seventh screen 312 to perform display at a target refresh rate of 60 Hz. The fourth enable signal outputted by the display driver chip 320 to the eighth screen 313 is GSTV2_P, and the fourth enable signal GSTV2_P corresponding to the eighth screen 313 is configured for driving the eighth screen 313 to perform display at a target refresh rate of 30 Hz. The fourth enable signal outputted by the display driver chip 320 to the ninth screen 314 is GSTV3_P, and the fourth enable signal GSTV3_P corresponding to the ninth screen 314 is configured for driving the ninth screen 314 to perform display at a target refresh rate of 120 Hz.

It may be understood that the first electronic device 100 shown in FIG. 1 may also include the display driver chip 320. In this case, the display driver chip 320 may output respective corresponding fourth enable signals to the first screen 111 and the second screen 112. The fourth enable signal corresponding to the first screen 111 may drive the first screen 111 to perform display at a target refresh rate of 60 Hz, and the fourth enable signal corresponding to the second screen 112 may drive the second screen 112 to perform display at a target refresh rate of 120 Hz.

Correspondingly, the second electronic device 200 shown in FIG. 2 may also include the display driver chip 320. In this case, the display driver chip 320 may output respective corresponding fourth enable signals to the third screen 211, the fourth screen 212, and the fifth screen 213. The fourth enable signal corresponding to the third screen 211 may drive the third screen 211 to perform display at a target refresh rate of 60 Hz. The fourth enable signal corresponding to the fourth screen 212 may drive the fourth screen 212 to perform display at a target refresh rate of 60 Hz. The fourth enable signal corresponding to the fifth screen 213 may drive the fifth screen 213 to perform display at a target refresh rate of 120 Hz.

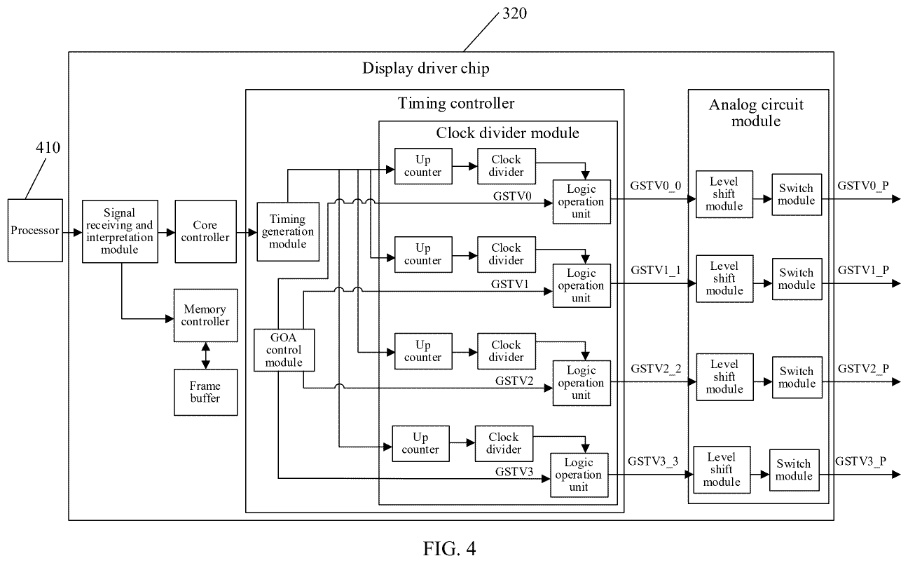

As an example, FIG. 4 is a schematic structural diagram of a display driver chip according to an embodiment of this application. Referring to FIG. 4, the display driver chip 320 may be connected to a processor 410. In addition, the display driver chip 320 may further be connected to a display (not shown in FIG. 4). For example, the display driver chip 320 may further be connected to the third display 310 shown in FIG. 3.

It should be noted that, the display driver chip 320 shown in FIG. 4 may generate fourth enable signal corresponding to the four display areas. In other words, the display to which the display driver chip 320 shown in FIG. 4 is connected may include four display areas.

In some embodiments, the processor 410 may include one or more processing units. For example, the processor 410 may include a system on chip (SOC), an application processor (AP), a modem processor, a graphics processing unit (GPU), an image signal processor (ISP), a controller, a video codec, a digital signal processor (DSP), a baseband processor, and/or a neural-network processing unit (NPU). Different processing units may be separate devices, or may be integrated into one or more processors.

The controller may generate an operation control signal based on an instruction operation code and a time sequence signal, to complete control of instruction fetching and instruction execution.

The memory may be further disposed in the processor 410, and is configured to store instructions and data. In some embodiments, the memory in the processor 410 is a cache memory. The memory may store instructions or data recently used or repeatedly used by the processor 410. If needing to use the instructions or the data again, the processor 410 may invoke the instructions or the data from the memory. This avoids repeated access and reduces a wait time of the processor 410, thereby improving efficiency of a system.

The display is configured to display an image, display a video, receive a flicking operation, and the like. The display includes a display panel. The display panel may be a liquid crystal display (LCD), an organic light-emitting diode (OLED), an active-matrix organic light-emitting diode (AMOLED), a flexible light-emitting diode (FLED), a Miniled, MicroLed, Micro-oLed, a quantum dot light-emitting diode (QLED), or the like.

In embodiments of this application, the display driver chip 320 may also be referred to as a display driver integrated circuit (DDIC) chip. The display driver chip 320 may include a signal receiving and interpretation module (i.e., an RX command Processor), a core controller (i.e., a Core controller), a memory controller (i.e., a Memory controller), a frame buffer (i.e., a Frame buffer), a timing controller (i.e., a Video timing Controller), and an analog circuit module. The timing controller further includes a timing generation module, a GOA control module (i.e., a GOA controller), and a clock divider module. The clock divider module includes a clock divider submodule corresponding to each display area. Each clock divider submodule includes an up counter, a clock divider, and a logic operation unit. An example in which the display of the electronic device includes four display areas is used, and the clock divider module includes four up counters, four clock dividers, and four logic operation units. In some embodiments, each up counter may be divided into an adder and a counter.

The analog circuit module includes a level shift module (i.e., a level shift) and a switch module (i.e., hiw_switch) that correspond to each display area.

In embodiments of this application, the processor 410 is connected to the signal receiving and interpretation module. The signal receiving and interpretation module is further connected to the core controller and the memory controller. The memory controller is further connected to the frame buffer. The core controller is further connected to the timing generation module. The timing generation module is connected to an up counter corresponding to each display area. The up counter corresponding to each display area is connected to a clock divider corresponding to each display area. The clock divider corresponding to each display area is connected to a logic operation unit corresponding to each display area. The GOA control module is connected to the logic operation unit corresponding to each display area. The logic operation unit corresponding to each display area is connected to the level shift module corresponding to each display area. The level shift module corresponding to each display area is connected to the switch module corresponding to each display area. The switch module corresponding to each display area is connected to a GOA circuit corresponding to the display area.

It may be understood that the structure shown in this embodiment of this application does not constitute a specific limitation on the display driver chip 320. In some other embodiments of this application, the display driver chip 320 may include more or fewer components than those shown in the figure, or combine some components, or split some components, or have different component arrangements.

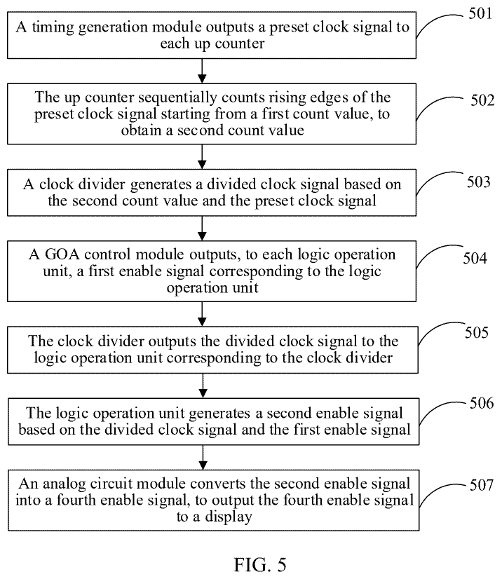

For example, FIG. 5 is a schematic flowchart of a method for setting a refresh rate according to an embodiment of this application. The method for setting a refresh rate is applicable to the display driver chip 320 shown in FIG. 4. As shown in FIG. 5, the method for setting a refresh rate may specifically include the following steps.

Step 501: The timing generation module outputs the preset clock signal to each up counter.

In some embodiments, the timing generation module is disposed in the timing controller. The timing generation module may generate the preset clock signal and send the preset clock signal to the up counter corresponding to each display area.

The preset clock signal may be configured for generating a divided clock signal of each display area, and a frequency of the preset clock signal may be M times of a frequency of a to-be-generated divided clock signal, where M is a positive integer. For example, the frequency of the preset clock signal may be 120 Hz, and if M is equal to 3, the frequency of the corresponding divided clock signal is 40 Hz.

In some other embodiments, the timing generation module may generate a reset signal in addition to the preset clock signal. In this case, the timing generation module may output the preset clock signal and the reset signal to each up counter.

The reset signal is a signal originally configured for resetting in the timing controller, and may participate in a process of obtaining a second count value through counting by the up counter corresponding to each display area, so that the clock divider corresponding to each display area may generate the divided clock signal of each display area based on the second count value and the preset clock signal.

Step 502: The up counter sequentially counts rising edges of the preset clock signal starting from a first count value, to obtain a second count value.

For the up counter corresponding to each display area, the up counter sequentially counts the rising edges of the preset clock signal starting from the first count value, to obtain the second count value corresponding to the display area.

In some embodiments, the first count value may be 0. Certainly, the first count value may alternatively be another value. For example, the first count value may alternatively be 1 or the like.

When the up counter corresponding to each display area counts the second count value, if either of the following two cases exists, the up counter needs to start to count again from the first count value.

In a first case, when a difference between the second count value corresponding to each display area and the first count value is equal to the clock division parameter corresponding to the display area, the up counter starts to count again from the first count value. In other words, when the difference between the second count value corresponding to each display area and the first count value is equal to a difference between the clock division parameter corresponding to the display area and 1, the up counter starts to count again from the first count value next time.

For example, for a display area, an example in which a clock division parameter corresponding to the display area is equal to 3 and the first count value is equal to 0 is used. When the second count value corresponding to the display area is incremented to 3, the up counter sets the second count value to zero, sets the second count value at this time from 3 to 0, and the up counter starts to count again from 0.

In a second case, when the reset signal is at a falling edge, the up counter starts to count again from the first count value.

An example in which the first count value is equal to 0 is used. When the reset signal is at a falling edge, it indicates that the reset signal needs to reset the timing controller. In this case, the up counter is reset to zero, so that the up counter corresponding to each display area starts to count again from 0.

It can be learned that, in a process of counting by the up counter to obtain the second count value, the clock division parameter of each display area needs to be used, and the clock division parameter of each display area may be obtained in the following manner: The signal receiving and interpretation module parses a data packet sent by a processor, to obtain display data corresponding to each display area and a target refresh rate corresponding to each display area. The signal receiving and interpretation module sends the display data corresponding to each display area to the memory controller, and sends the target refresh rate corresponding to each display area to the core controller. The memory controller stores the display data corresponding to each display area in the frame buffer. The core controller sends the target refresh rate corresponding to each display area to the timing controller. The timing controller generates the clock division parameter corresponding to each display area based on the target refresh rate corresponding to each display area.

The processor may send the data packet to the signal receiving and interpretation module. The data packet includes the display data required by each display area and the target refresh rate corresponding to each display area. After receiving the data packet sent by the processor, the signal receiving and interpretation module unpacks the data packet, to obtain the display data corresponding to each display area and the target refresh rate corresponding to each display area.

The signal receiving and interpretation module sends the display data corresponding to each display area to the memory controller. The memory controller stores the display data corresponding to each display area in the frame buffer. The display data is display data that needs to be written into a pixel driver circuit in the display area, to display an image in the display area.

The signal receiving and interpretation module further sends the target refresh rate corresponding to each display area to the core controller. The core controller sends the target refresh rate corresponding to each display area to the timing controller. The timing controller generates the clock division parameter corresponding to each display area based on the target refresh rate corresponding to each display area. Specifically, the core controller may send the target refresh rate corresponding to each display area to the timing generation module in the timing controller. The timing generation module may generate the clock division parameter corresponding to each display area based on the target refresh rate corresponding to each display area, and then transmit these clock division parameters to the up counter, so that the up counter may obtain the second count value through counting.

An example in which the third electronic device 300 shown in FIG. 3 includes four display areas, namely, the sixth screen 311, the seventh screen 312, the eighth screen 313, and the ninth screen 314 is used. The target refresh rate corresponding to the sixth screen 311 is 40 Hz. Because the frequency of the preset clock signal is 120 Hz, the clock division parameter corresponding to the sixth screen 311 is 3. The target refresh rate corresponding to the seventh screen 312 is 60 Hz. Because the frequency of the preset clock signal is 120 Hz, the clock division parameter corresponding to the seventh screen 312 is 2. The target refresh rate corresponding to the eighth screen 313 is 30 Hz. Because the frequency of the preset clock signal is 120 Hz, the clock division parameter corresponding to the eighth screen 313 is 4. The target refresh rate corresponding to the ninth screen 314 is 120 Hz. Because the frequency of the preset clock signal is 120 Hz, the clock division parameter corresponding to the ninth screen 314 is 1. In other words, the clock division parameter corresponding to each display area is equal to a ratio of the frequency of the preset clock signal to the target refresh rate required for the display area.

Step 503: The clock divider generates a divided clock signal based on the second count value and the preset clock signal.

After obtaining the second count value, the up counter corresponding to each display area transmits the second count value to the clock divider corresponding to the up counter. The clock divider corresponding to each display area may generate the divided clock signal corresponding to each display area based on the second count value and the preset clock signal.

The divided clock signal is a new generated clock signal. A frequency of the divided clock signal may be 1/M times of the frequency of the preset clock signal. A period of the divided clock signal may be M times of a period of the preset clock signal.

In some embodiments, the up counter and the clock divider that correspond to each display area are located in a clock divider module of the timing controller. Therefore, through step 502, the clock divider module sequentially counts the rising edges of the preset clock signal starting from the first count value, to obtain the second count value corresponding to each display area, and through step 503, the clock divider module generates the divided clock signal corresponding to each display area based on the second count value corresponding to each display area and the preset clock signal.

When a difference between the second count value corresponding to each display area and the first count value is equal to the clock division parameter corresponding to the display area, the clock divider module starts to count again from the first count value. In addition, when the reset signal in the timing controller is at a falling edge, the clock divider module starts to count again from the first count value. The clock division parameter is a positive integer.

In summary, through step 501 to step 503, the timing controller generates the divided clock signal corresponding to each display area based on the preset clock signal and the clock division parameter corresponding to each display area.

Step 504: The GOA control module outputs, to each logic operation unit, the first enable signal corresponding to the logic operation unit.

Step 505: The clock divider outputs the divided clock signal to the logic operation unit corresponding to the clock divider.

Step 506: The logic operation unit generates the second enable signal based on the divided clock signal and the first enable signal.

In some embodiments, a GOA controller is further disposed in the timing controller, and the GOA controller may output, to the logic operation unit corresponding to each display area, the first enable signal corresponding to the logic operation unit. After generating the corresponding divided clock signal, the clock divider corresponding to each display area may output the divided clock signal to the corresponding logic operation unit.

The logic operation unit corresponding to each display area generates the second enable signal corresponding to each display area based on the divided clock signal corresponding to each display area and the first enable signal corresponding to each display area.

Because the logic operation unit is located in the clock divider module, and the clock divider module is located in the timing controller, the foregoing step 504 to step 506 enable the timing controller to generate the second enable signal corresponding to each display area based on the divided clock signal corresponding to each display area and the corresponding first enable signal.

The second enable signal corresponding to each display area is configured for driving the display area corresponding to the second enable signal to perform display at a target refresh rate. Frequencies of the second enable signals corresponding to at least some of the display areas are different, and the target refresh rates corresponding to at least some of the display areas are also different.

An example in which the third electronic device 300 shown in FIG. 3 includes four display areas, namely, the sixth screen 311, the seventh screen 312, the eighth screen 313, and the ninth screen 314 is used. A frequency of the second enable signal corresponding to the sixth screen 311 is 40 Hz, and the target refresh rate corresponding to the sixth screen 311 is also 40 Hz. A frequency of the second enable signal corresponding to the seventh screen 312 is 60 Hz, and the target refresh rate corresponding to the seventh screen 312 is also 60 Hz. A frequency of the second enable signal corresponding to the eighth screen 313 is 30 Hz, and the target refresh rate corresponding to the eighth screen 313 is also 30 Hz. A frequency of the second enable signal corresponding to the ninth screen 314 is 120 Hz, and the target refresh rate corresponding to the ninth screen 314 is also 120 Hz.

Step 507: The analog circuit module converts the second enable signal into a fourth enable signal, to output the fourth enable signal to the display.

In some embodiments, the analog circuit module is further disposed in the timing controller. Because the second enable signal corresponding to each display area is a digital low-voltage signal, and a signal configured for driving the display area to perform display is an analog high-voltage signal, the analog circuit module is disposed between the clock divider module and the display. The analog circuit module may convert the second enable signal corresponding to each display area into the fourth enable signal, to output the fourth enable signal corresponding to each display area to the display.

The fourth enable signal corresponding to each display area is an input signal of a first-level GOA unit corresponding to each display area. The second enable signal is a digital signal. The fourth enable signal is an analog signal. A level of the fourth enable signal is greater than a level of the second enable signal.

In a possible implementation, the analog circuit module includes an analog circuit submodule corresponding to each display area, and each analog circuit submodule includes the level shift module and the switch module. For each display area, the logic operation unit is connected to the level shift module corresponding to the logic operation unit, and the level shift module is further connected to the switch module corresponding to the level shift module.

The level shift module is configured to perform level shift on a second level signal, to convert a low-voltage signal into a high-voltage signal. The switch module is configured to control a turned-on or turned-off state when the signal after the level shift is at a low level or a high level.

It should be noted that a frequency of the fourth enable signal is the same as the frequency of the second enable signal. In summary, because the fourth enable signal corresponding to each display area is an input signal of the first-level GOA unit corresponding to the display area, the second enable signal only changes in level compared with the fourth enable signal, the second enable signal is a digital signal, and the fourth enable signal is an analog signal, the second enable signal corresponding to each display area may be configured for generating the input signal of the first-level GOA unit corresponding to the display area.

In addition, in embodiments of this application, the GOA controller may further output a GCK/GCB, an ECK/ECB, an ESTV signal, and the like. The GCK/GCB and ECK/ECB are in fact some clock signals in a GOA circuit of the display. Alternatively, the ESTV signal may be processed by the analog circuit module to generate an ESTV_P signal. The ESTV_P signal is in fact a light-emitting control signal (i.e., an EM signal) of the pixel driver circuit after the ESTV P signal passes through the GOA circuit.

It should be noted that, a level shift module and a switch module that correspond to the ESTV_P signal are separately disposed in the analog circuit module, the level shift module corresponding to the ESTV_P signal and a level shift module corresponding to the second enable signal are not shared modules, and the switch module corresponding to the ESTV_P signal and a switch module corresponding to the second enable signal are not shared modules.

Specific processes of generating the divided clock signal based on the second count value and the preset clock signal, and generating the second enable signal based on the divided clock signal and the first enable signal in embodiments of this application are described below separately from four optional implementations.

In embodiments of this application, the display includes a GOA circuit corresponding to each display area, each GOA circuit includes a plurality of levels of cascaded GOA units, and the second enable signal corresponding to each display area is configured for generating the input signal of the first-level GOA unit corresponding to the display area. In fact, after the second enable signal corresponding to each display area is processed by using the analog circuit module, the fourth enable signal corresponding to each display area may be obtained, and the fourth enable signal corresponding to each display area is the input signal of the first-level GOA unit corresponding to the display area.

A plurality of rows of pixel driver circuits are disposed in each display area, each pixel driver circuit in each row of pixel driver circuits includes a data write transistor, an output terminal of a GOA unit of each level is connected to a gate of each data write transistor in a same row of pixel driver circuits, and an output signal of the GOA unit of each level is configured for controlling turn-on/turn-off of the data write transistor connected to the GOA unit. In addition, an output signal of a (K-1)^{th}-level GOA unit is further used as an input signal of a K^{th}-level GOA unit. K is an integer greater than 1.

In a first possible implementation, the data write transistor is an N-type transistor. In this case, the clock divider module sets, for each display area, the preset clock signal when the second count value is equal to the first count value to a high level, and sets the preset clock signal when the second count value is not equal to the first count value to a low level, to obtain the divided clock signal. The clock divider module performs an AND operation on the divided clock signal corresponding to each display area and the corresponding first enable signal, to obtain the second enable signal corresponding to each display area.

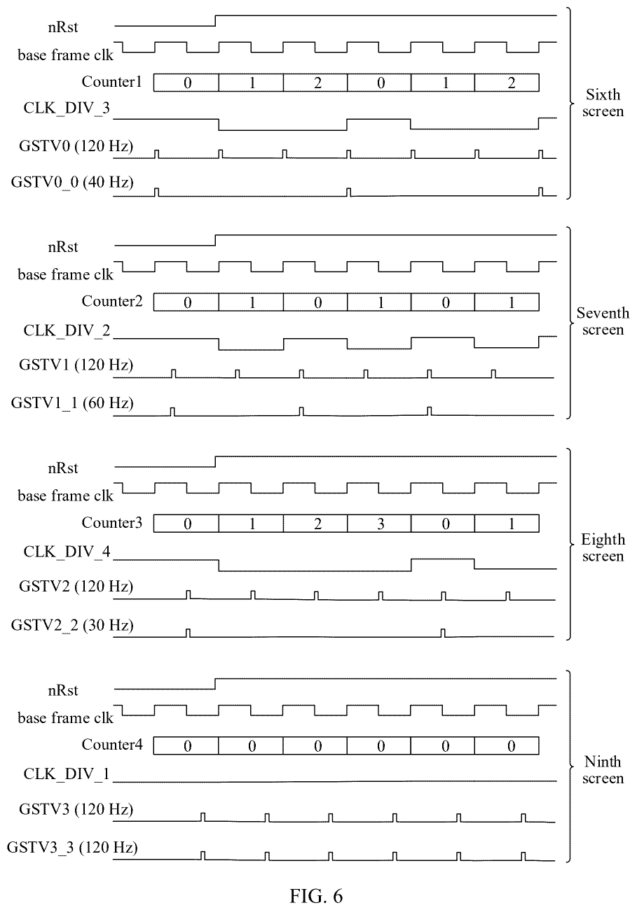

An example in which the first count value is 0 and the third electronic device 300 shown in FIG. 3 includes four display areas, namely, the sixth screen 311, the seventh screen 312, the eighth screen 313, and the ninth screen 314 is used. As shown in FIG. 6, the timing generation module in the timing controller respectively provides a preset clock signal (i.e., base frame clk) and a reset signal (i.e., nRst) to the up counter corresponding to the sixth screen 311, the up counter corresponding to the seventh screen 312, the up counter corresponding to the eighth screen 313, and the up counter corresponding to the ninth screen 314.

As shown in FIG. 6, because the clock division parameter corresponding to the sixth screen 311 is 3, the up counter corresponding to the sixth screen 311 sequentially counts the rising edges of the preset clock signal sequentially starting from 0, to obtain the second count value corresponding to the sixth screen 311. The second count value (i.e., Counter1) corresponding to the sixth screen 311 is 0, 1, 2, 0, 1, 2, . . . The clock divider corresponding to the sixth screen 311 may set the preset clock signal when the second count value is equal to 0 to a high level, set the preset clock signal when the second count value is equal to 1 to a low level, and also set the preset clock signal when the second count value is equal to 2 to a low level, to obtain the divided clock signal (i.e., CLK_DIV_3) corresponding to the sixth screen 311. The first enable signal corresponding to the sixth screen 311 is GSTV0, and a frequency of the first enable signal is 120 Hz. The logic operation unit corresponding to the sixth screen 311 may perform an AND operation on the divided clock signal corresponding to the sixth screen 311 and the first enable signal corresponding to the sixth screen 311, to obtain the second enable signal (i.e., GSTV0_0) corresponding to the sixth screen 311.

Therefore, a frequency of the second enable signal corresponding to the sixth screen 311 may be 40 Hz, the second enable signal corresponding to the sixth screen 311 is a valid signal when being at a high level, and the second enable signal corresponding to the sixth screen 311 is an invalid signal when being at a low level. After the second enable signal corresponding to the sixth screen 311 is processed by using the analog circuit module, the fourth enable signal (i.e., GSTV0_P) corresponding to the sixth screen 311 may be obtained, the fourth enable signal corresponding to the sixth screen 311 is the input signal of the first-level GOA unit corresponding to the sixth screen 311, and the frequency of the fourth enable signal corresponding to the sixth screen 311 is also 40 Hz. The fourth enable signal corresponding to the sixth screen 311 is also a valid signal when being at a high level, and an output signal after the fourth enable signal passes through the GOA unit is also a valid signal when being at a high level. The data write transistor connected to the GOA unit may be controlled to be turned on. The second enable signal corresponding to the sixth screen 311 is an invalid signal when being at a low level, and an output signal after the second enable signal passes through the GOA unit is also an invalid signal when being is at a low level. The data write transistor connected to the GOA unit may be controlled to be turned off. In this way, the sixth screen 311 may be driven to perform display at a target refresh rate of 40 Hz.

As shown in FIG. 6, because the clock division parameter corresponding to the seventh screen 312 is 2, the up counter corresponding to the seventh screen 312 sequentially counts the rising edges of the preset clock signal sequentially starting from 0, to obtain the second count value corresponding to the seventh screen 312. The second count value (i.e., Counter2) corresponding to the seventh screen 312 is 0, 1, 0, 1, 0, 1, . . . The clock divider corresponding to the seventh screen 312 may set the preset clock signal when the second count value is equal to 0 to a high level, and set the preset clock signal when the second count value is equal to 1 to a low level, to obtain the divided clock signal (i.e., CLK_DIV_2) corresponding to the seventh screen 312. The first enable signal corresponding to the seventh screen 312 is GSTV1, and a frequency of the first enable signal is 120 Hz. The logic operation unit corresponding to the seventh screen 312 may perform an AND operation on the divided clock signal corresponding to the seventh screen 312 and the first enable signal corresponding to the seventh screen 312, to obtain the second enable signal (i.e., GSTV1_1) corresponding to the seventh screen 312.

Therefore, a frequency of the second enable signal corresponding to the seventh screen 312 may be 60 Hz, the second enable signal corresponding to the seventh screen 312 is a valid signal when being at a high level, and the second enable signal corresponding to the seventh screen 312 is an invalid signal when being at a low level. After the second enable signal corresponding to the seventh screen 312 is processed by using the analog circuit module, the fourth enable signal (i.e., GSTV1_P) corresponding to the seventh screen 312 may be obtained, the fourth enable signal corresponding to the seventh screen 312 is the input signal of the first-level GOA unit corresponding to the seventh screen 312, and the frequency of the fourth enable signal corresponding to the seventh screen 312 is also 60 Hz. The fourth enable signal corresponding to the seventh screen 312 is also a valid signal when being at a high level, and an output signal after the fourth enable signal passes through the GOA unit is also a valid signal when being at a high level. The data write transistor connected to the GOA unit may be controlled to be turned on. The fourth enable signal corresponding to the seventh screen 312 is an invalid signal when being at a low level, and an output signal after the fourth enable signal passes through the GOA unit is also an invalid signal when being is at a low level. The data write transistor connected to the GOA unit may be controlled to be turned off. In this way, the seventh screen 312 may be driven to perform display at a target refresh rate of 60 Hz.

As shown in FIG. 6, because the clock division parameter corresponding to the eighth screen 313 is 4, the up counter corresponding to the eighth screen 313 sequentially counts the rising edges of the preset clock signal sequentially starting from 0, to obtain the second count value corresponding to the eighth screen 313. The second count value (i.e., Counter3) corresponding to the eighth screen 313 is 0, 1, 2, 3, 0, 1, 2, 3, . . . The clock divider corresponding to the eighth screen 313 may set the preset clock signal when the second count value is equal to 0 to a high level, set the preset clock signal when the second count value is equal to 1 to a low level, set also set the preset clock signal when the second count value is equal to 2 to a low level, and set also set the preset clock signal when the second count value is equal to 3 to a low level, to obtain the divided clock signal (i.e., CLK_DIV_4) corresponding to the eighth screen 313. The first enable signal corresponding to the eighth screen 313 is GSTV2, and a frequency of the first enable signal is 120 Hz. The logic operation unit corresponding to the eighth screen 313 may perform an AND operation on the divided clock signal corresponding to the eighth screen 313 and the first enable signal corresponding to the eighth screen 313, to obtain the second enable signal (i.e., GSTV2_2) corresponding to the eighth screen 313.

Therefore, a frequency of the second enable signal corresponding to the eighth screen 313 may be 30 Hz, the second enable signal corresponding to the eighth screen 313 is a valid signal when being at a high level, and the second enable signal corresponding to the eighth screen 313 is an invalid signal when being at a low level. After the second enable signal corresponding to the eighth screen 313 is processed by using the analog circuit module, the fourth enable signal (i.e., GSTV2_P) corresponding to the eighth screen 313 may be obtained, the fourth enable signal corresponding to the eighth screen 313 is the input signal of the first-level GOA unit corresponding to the eighth screen 313, and the frequency of the fourth enable signal corresponding to the eighth screen 313 is also 30 Hz. The fourth enable signal corresponding to the eighth screen 313 is also a valid signal when being at a high level, and an output signal after the fourth enable signal passes through the GOA unit is also a valid signal when being at a high level. The data write transistor connected to the GOA unit may be controlled to be turned on. The fourth enable signal corresponding to the eighth screen 313 is an invalid signal when being at a low level, and an output signal after the fourth enable signal passes through the GOA unit is also an invalid signal when being is at a low level. The data write transistor connected to the GOA unit may be controlled to be turned off. In this way, the eighth screen 313 may be driven to perform display at a target refresh rate of 30 Hz.

As shown in FIG. 6, because the clock division parameter corresponding to the ninth screen 314 is 1, the up counter corresponding to the ninth screen 314 sequentially counts the rising edges of the preset clock signal sequentially starting from 0, to obtain the second count value corresponding to the ninth screen 314. The second count value (i.e., Counter4) corresponding to the ninth screen 314 is 0, 0, 0, 0, . . . The clock divider corresponding to the ninth screen 314 may set the preset clock signal when the second count value is equal to 0 to a high level, to obtain the divided clock signal (i.e., CLK_DIV_1) corresponding to the ninth screen 314. The first enable signal corresponding to the ninth screen 314 is GSTV3, and a frequency of the first enable signal is 120 Hz. The logic operation unit corresponding to the ninth screen 314 may perform an AND operation on the divided clock signal corresponding to the ninth screen 314 and the first enable signal corresponding to the ninth screen 314, to obtain the second enable signal (i.e., GSTV3_3) corresponding to the ninth screen 314.

Therefore, a frequency of the second enable signal corresponding to the ninth screen 314 may be 120 Hz, the second enable signal corresponding to the ninth screen 314 is a valid signal when being at a high level, and the second enable signal corresponding to the ninth screen 314 is an invalid signal when being at a low level. After the second enable signal corresponding to the ninth screen 314 is processed by using the analog circuit module, the fourth enable signal (i.e., GSTV3_P) corresponding to the ninth screen 314 may be obtained, the fourth enable signal corresponding to the ninth screen 314 is the input signal of the first-level GOA unit corresponding to the ninth screen 314, and the frequency of the fourth enable signal corresponding to the ninth screen 314 is also 120 Hz. The fourth enable signal corresponding to the ninth screen 314 is also a valid signal when being at a high level, and an output signal after the fourth enable signal passes through the GOA unit is also a valid signal when being at a high level. The data write transistor connected to the GOA unit may be controlled to be turned on. The second enable signal corresponding to the ninth screen 314 is an invalid signal when being at a low level, and an output signal after the second enable signal passes through the GOA unit is also an invalid signal when being is at a low level. The data write transistor connected to the GOA unit may be controlled to be turned off. In this way, the ninth screen 314 may be driven to perform display at a target refresh rate of 120 Hz.

In a second possible implementation, the data write transistor is a P-type transistor. In this case, the clock divider module sets, for each display area, the preset clock signal when the second count value is equal to the first count value to a high level, and sets the preset clock signal when the second count value is not equal to the first count value to a low level, to obtain the divided clock signal. The clock divider module performs a NOT operation on the first enable signal corresponding to each display area, to obtain a third enable signal corresponding to each display area. The clock divider module performs a NAND operation on the divided clock signal corresponding to each display area and the corresponding third enable signal, to obtain the second enable signal corresponding to each display area.

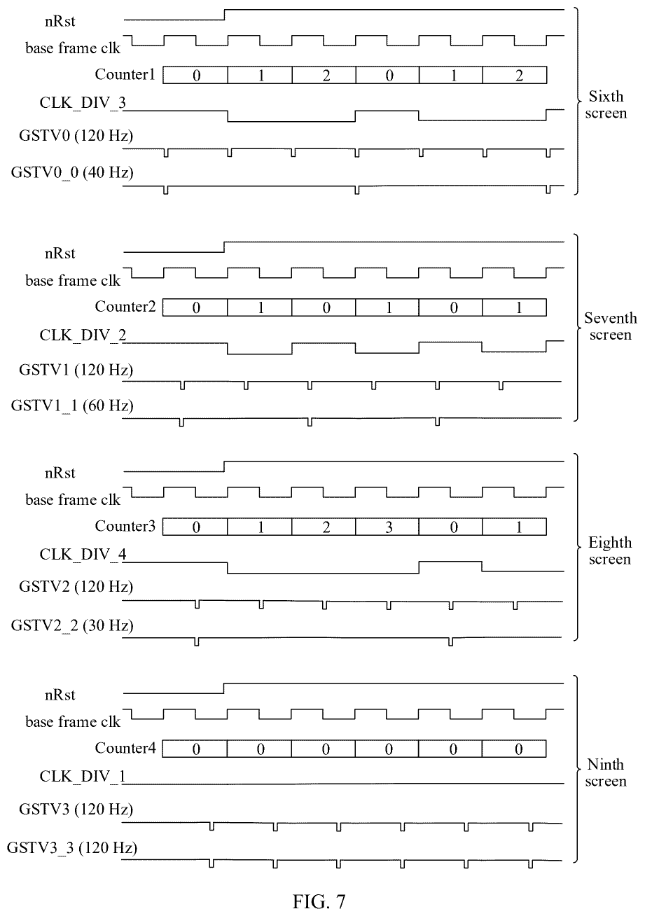

An example in which the first count value is 0 and the third electronic device 300 shown in FIG. 3 includes four display areas, namely, the sixth screen 311, the seventh screen 312, the eighth screen 313, and the ninth screen 314 is used. As shown in FIG. 7, the timing generation module in the timing controller respectively provides a preset clock signal (i.e., base frame clk) and a reset signal (i.e., nRst) to the up counter corresponding to the sixth screen 311, the up counter corresponding to the seventh screen 312, the up counter corresponding to the eighth screen 313, and the up counter corresponding to the ninth screen 314.

As shown in FIG. 7, because the clock division parameter corresponding to the sixth screen 311 is 3, the up counter corresponding to the sixth screen 311 sequentially counts the rising edges of the preset clock signal sequentially starting from 0, to obtain the second count value corresponding to the sixth screen 311. The second count value (i.e., Counter1) corresponding to the sixth screen 311 is 0, 1, 2, 0, 1, 2, . . . The clock divider corresponding to the sixth screen 311 may set the preset clock signal when the second count value is equal to 0 to a high level, set the preset clock signal when the second count value is equal to 1 to a low level, and also set the preset clock signal when the second count value is equal to 2 to a low level, to obtain the divided clock signal (i.e., CLK_DIV_3) corresponding to the sixth screen 311. The first enable signal corresponding to the sixth screen 311 is GSTV0, and a frequency of the first enable signal is 120 Hz. The logic operation unit corresponding to the sixth screen 311 may perform a NOT operation on the first enable signal corresponding to the sixth screen 311, to obtain the third enable signal corresponding to the sixth screen 311. The logic operation unit corresponding to the sixth screen 311 then performs a NAND operation on the divided clock signal corresponding to the sixth screen 311 and the third enable signal corresponding to the sixth screen 311, to obtain the second enable signal (i.e., GSTV0_0) corresponding to the sixth screen 311.

Therefore, a frequency of the second enable signal corresponding to the sixth screen 311 may be 40 Hz, the second enable signal corresponding to the sixth screen 311 is a valid signal when being at a low level, and the second enable signal corresponding to the sixth screen 311 is an invalid signal when being at a high level. After the second enable signal corresponding to the sixth screen 311 is processed by using the analog circuit module, the fourth enable signal (i.e., GSTV0_P) corresponding to the sixth screen 311 may be obtained, the fourth enable signal corresponding to the sixth screen 311 is the input signal of the first-level GOA unit corresponding to the sixth screen 311, and the frequency of the fourth enable signal corresponding to the sixth screen 311 is also 40 Hz. The fourth enable signal corresponding to the sixth screen 311 is also a valid signal when being at a low level, and an output signal after the fourth enable signal passes through the GOA unit is also a valid signal when being at a low level. The data write transistor connected to the GOA unit may be controlled to be turned on. The second enable signal corresponding to the sixth screen 311 is an invalid signal when being at a high level, and an output signal after the second enable signal passes through the GOA unit is also an invalid signal when being is at a high level. The data write transistor connected to the GOA unit may be controlled to be turned off. In this way, the sixth screen 311 may be driven to perform display at a target refresh rate of 40 Hz.

As shown in FIG. 7, because the clock division parameter corresponding to the seventh screen 312 is 2, the up counter corresponding to the seventh screen 312 sequentially counts the rising edges of the preset clock signal sequentially starting from 0, to obtain the second count value corresponding to the seventh screen 312. The second count value (i.e., Counter2) corresponding to the seventh screen 312 is 0, 1, 0, 1, 0, 1, . . . The clock divider corresponding to the seventh screen 312 may set the preset clock signal when the second count value is equal to 0 to a high level, and set the preset clock signal when the second count value is equal to 1 to a low level, to obtain the divided clock signal (i.e., CLK_DIV_2) corresponding to the seventh screen 312. The first enable signal corresponding to the seventh screen 312 is GSTV1, and a frequency of the first enable signal is 120 Hz. The logic operation unit corresponding to the seventh screen 312 may perform a NOT operation on the first enable signal corresponding to the seventh screen 312, to obtain the third enable signal corresponding to the seventh screen 312. The logic operation unit corresponding to the seventh screen 312 then performs a NAND operation on the divided clock signal corresponding to the seventh screen 312 and the third enable signal corresponding to the seventh screen 312, to obtain the second enable signal (i.e., GSTV1_1) corresponding to the seventh screen 312.

Therefore, a frequency of the second enable signal corresponding to the seventh screen 312 may be 60 Hz, the second enable signal corresponding to the seventh screen 312 is a valid signal when being at a low level, and the second enable signal corresponding to the seventh screen 312 is an invalid signal when being at a high level. After the second enable signal corresponding to the seventh screen 312 is processed by using the analog circuit module, the fourth enable signal (i.e., GSTV1_P) corresponding to the seventh screen 312 may be obtained, the fourth enable signal corresponding to the seventh screen 312 is the input signal of the first-level GOA unit corresponding to the seventh screen 312, and the frequency of the fourth enable signal corresponding to the seventh screen 312 is also 60 Hz. The fourth enable signal corresponding to the seventh screen 312 is also a valid signal when being at a low level, and an output signal after the fourth enable signal passes through the GOA unit is also a valid signal when being at a low level. The data write transistor connected to the GOA unit may be controlled to be turned on. The fourth enable signal corresponding to the seventh screen 312 is an invalid signal when being at a high level, and an output signal after the fourth enable signal passes through the GOA unit is also an invalid signal when being is at a high level. The data write transistor connected to the GOA unit may be controlled to be turned off. In this way, the seventh screen 312 may be driven to perform display at a target refresh rate of 60 Hz.

As shown in FIG. 7, because the clock division parameter corresponding to the eighth screen 313 is 4, the up counter corresponding to the eighth screen 313 sequentially counts the rising edges of the preset clock signal sequentially starting from 0, to obtain the second count value corresponding to the eighth screen 313. The second count value (i.e., Counter3) corresponding to the eighth screen 313 is 0, 1, 2, 3, 0, 1, 2, 3, . . . The clock divider corresponding to the eighth screen 313 may set the preset clock signal when the second count value is equal to 0 to a high level, set the preset clock signal when the second count value is equal to 1 to a low level, set also set the preset clock signal when the second count value is equal to 2 to a low level, and set also set the preset clock signal when the second count value is equal to 3 to a low level, to obtain the divided clock signal (i.e., CLK_DIV_4) corresponding to the eighth screen 313. The first enable signal corresponding to the eighth screen 313 is GSTV2, and a frequency of the first enable signal is 120 Hz. The logic operation unit corresponding to the eighth screen 313 may perform a NOT operation on the first enable signal corresponding to the eighth screen 313, to obtain the third enable signal corresponding to the eighth screen 313. The logic operation unit corresponding to the eighth screen 313 then performs a NAND operation on the divided clock signal corresponding to the eighth screen 313 and the third enable signal corresponding to the eighth screen 313, to obtain the second enable signal (i.e., GSTV2_2) corresponding to the eighth screen 313.

Therefore, a frequency of the second enable signal corresponding to the eighth screen 313 may be 30 Hz, the second enable signal corresponding to the eighth screen 313 is a valid signal when being at a low level, and the second enable signal corresponding to the eighth screen 313 is an invalid signal when being at a high level. After the second enable signal corresponding to the eighth screen 313 is processed by using the analog circuit module, the fourth enable signal (i.e., GSTV2_P) corresponding to the eighth screen 313 may be obtained, the fourth enable signal corresponding to the eighth screen 313 is the input signal of the first-level GOA unit corresponding to the eighth screen 313, and the frequency of the fourth enable signal corresponding to the eighth screen 313 is also 30 Hz. The fourth enable signal corresponding to the eighth screen 313 is also a valid signal when being at a low level, and an output signal after the fourth enable signal passes through the GOA unit is also a valid signal when being at a low level. The data write transistor connected to the GOA unit may be controlled to be turned on. The fourth enable signal corresponding to the eighth screen 313 is an invalid signal when being at a high level, and an output signal after the fourth enable signal passes through the GOA unit is also an invalid signal when being is at a high level. The data write transistor connected to the GOA unit may be controlled to be turned off. In this way, the eighth screen 313 may be driven to perform display at a target refresh rate of 30 Hz.

As shown in FIG. 7, because the clock division parameter corresponding to the ninth screen 314 is 1, the up counter corresponding to the ninth screen 314 sequentially counts the rising edges of the preset clock signal sequentially starting from 0, to obtain the second count value corresponding to the ninth screen 314. The second count value (i.e., Counter4) corresponding to the ninth screen 314 is 0, 0, 0, 0, . . . The clock divider corresponding to the ninth screen 314 may set the preset clock signal when the second count value is equal to 0 to a high level, to obtain the divided clock signal (i.e., CLK_DIV_1) corresponding to the ninth screen 314. The first enable signal corresponding to the ninth screen 314 is GSTV3, and a frequency of the first enable signal is 120 Hz. The logic operation unit corresponding to the ninth screen 314 may perform a NOT operation on the first enable signal corresponding to the ninth screen 314, to obtain the third enable signal corresponding to the ninth screen 314. The logic operation unit corresponding to the ninth screen 314 then performs a NAND operation on the divided clock signal corresponding to the ninth screen 314 and the third enable signal corresponding to the ninth screen 314, to obtain the second enable signal (i.e., GSTV3_3) corresponding to the ninth screen 314.

Therefore, a frequency of the second enable signal corresponding to the ninth screen 314 may be 120 Hz, the second enable signal corresponding to the ninth screen 314 is a valid signal when being at a low level, and the second enable signal corresponding to the ninth screen 314 is an invalid signal when being at a high level. After the second enable signal corresponding to the ninth screen 314 is processed by using the analog circuit module, the fourth enable signal (i.e., GSTV3_P) corresponding to the ninth screen 314 may be obtained, the fourth enable signal corresponding to the ninth screen 314 is the input signal of the first-level GOA unit corresponding to the ninth screen 314, and the frequency of the fourth enable signal corresponding to the ninth screen 314 is also 120 Hz. The fourth enable signal corresponding to the ninth screen 314 is also a valid signal when being at a low level, and an output signal after the fourth enable signal passes through the GOA unit is also a valid signal when being at a low level. The data write transistor connected to the GOA unit may be controlled to be turned on. The second enable signal corresponding to the ninth screen 314 is an invalid signal when being at a high level, and an output signal after the second enable signal passes through the GOA unit is also an invalid signal when being is at a high level. The data write transistor connected to the GOA unit may be controlled to be turned off. In this way, the ninth screen 314 may be driven to perform display at a target refresh rate of 120 Hz.

It should be noted that, for each display area, the first enable signal shown in FIG. 7 and the first enable signal shown in FIG. 6 are phase-inverted signals, and the GOA control module may select to output the first enable signal shown in FIG. 7 or the first enable signal shown in FIG. 6 according to an actual case.

In a third possible implementation, the data write transistor is an N-type transistor. In this case, the clock divider module sets, for each display area, the preset clock signal when the second count value is equal to the first count value to a low level, and sets the preset clock signal when the second count value is not equal to the first count value to a high level, to obtain the divided clock signal. The clock divider module performs a NOT operation on the first enable signal corresponding to each display area, to obtain a third enable signal corresponding to each display area. The clock divider module performs a NOR operation on the divided clock signal corresponding to each display area and the corresponding third enable signal, to obtain the second enable signal corresponding to each display area.

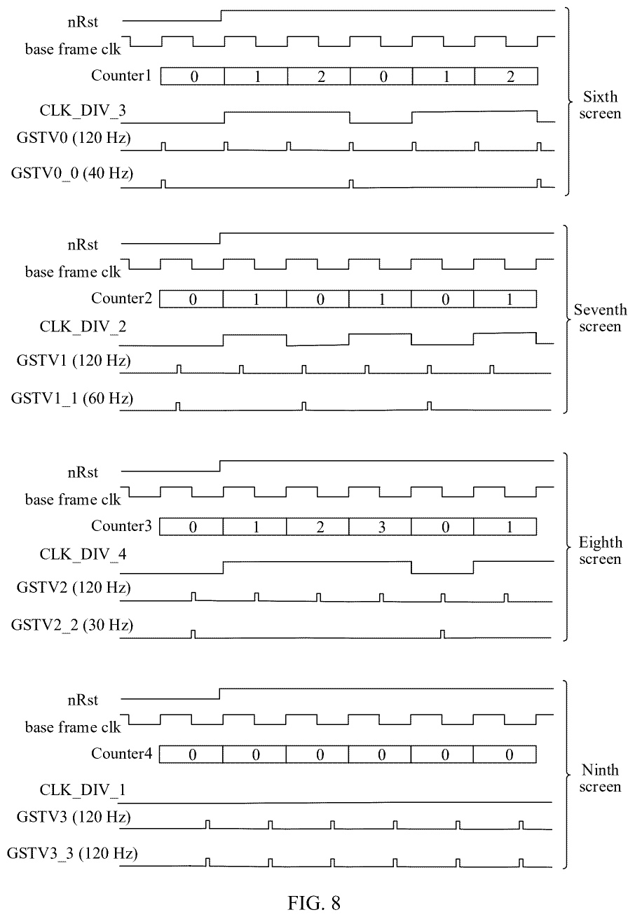

An example in which the first count value is 0 and the third electronic device 300 shown in FIG. 3 includes four display areas, namely, the sixth screen 311, the seventh screen 312, the eighth screen 313, and the ninth screen 314 is used. As shown in FIG. 8, the timing generation module in the timing controller respectively provides a preset clock signal (i.e., base frame clk) and a reset signal (i.e., nRst) to the up counter corresponding to the sixth screen 311, the up counter corresponding to the seventh screen 312, the up counter corresponding to the eighth screen 313, and the up counter corresponding to the ninth screen 314.

As shown in FIG. 8, because the clock division parameter corresponding to the sixth screen 311 is 3, the up counter corresponding to the sixth screen 311 sequentially counts the rising edges of the preset clock signal sequentially starting from 0, to obtain the second count value corresponding to the sixth screen 311. The second count value (i.e., Counter1) corresponding to the sixth screen 311 is 0, 1, 2, 0, 1, 2, . . . The clock divider corresponding to the sixth screen 311 may set the preset clock signal when the second count value is equal to 0 to a low level, set the preset clock signal when the second count value is equal to 1 to a high level, and also set the preset clock signal when the second count value is equal to 2 to a high level, to obtain the divided clock signal (i.e., CLK_DIV_3) corresponding to the sixth screen 311. The first enable signal corresponding to the sixth screen 311 is GSTV0, and a frequency of the first enable signal is 120 Hz. The logic operation unit corresponding to the sixth screen 311 may perform a NOT operation on the first enable signal corresponding to the sixth screen 311, to obtain the third enable signal corresponding to the sixth screen 311. The logic operation unit corresponding to the sixth screen 311 then performs a NOR operation on the divided clock signal corresponding to the sixth screen 311 and the third enable signal corresponding to the sixth screen 311, to obtain the second enable signal (i.e., GSTV0_0) corresponding to the sixth screen 311.

Therefore, a frequency of the second enable signal corresponding to the sixth screen 311 may be 40 Hz, the second enable signal corresponding to the sixth screen 311 is a valid signal when being at a high level, and the second enable signal corresponding to the sixth screen 311 is an invalid signal when being at a low level. After the second enable signal corresponding to the sixth screen 311 is processed by using the analog circuit module, the fourth enable signal (i.e., GSTV0_P) corresponding to the sixth screen 311 may be obtained, the fourth enable signal corresponding to the sixth screen 311 is the input signal of the first-level GOA unit corresponding to the sixth screen 311, and the frequency of the fourth enable signal corresponding to the sixth screen 311 is also 40 Hz. The fourth enable signal corresponding to the sixth screen 311 is also a valid signal when being at a high level, and an output signal after the fourth enable signal passes through the GOA unit is also a valid signal when being at a high level. The data write transistor connected to the GOA unit may be controlled to be turned on. The second enable signal corresponding to the sixth screen 311 is an invalid signal when being at a low level, and an output signal after the second enable signal passes through the GOA unit is also an invalid signal when being is at a low level. The data write transistor connected to the GOA unit may be controlled to be turned off. In this way, the sixth screen 311 may be driven to perform display at a target refresh rate of 40 Hz.

As shown in FIG. 8, because the clock division parameter corresponding to the seventh screen 312 is 2, the up counter corresponding to the seventh screen 312 sequentially counts the rising edges of the preset clock signal sequentially starting from 0, to obtain the second count value corresponding to the seventh screen 312. The second count value (i.e., Counter2) corresponding to the seventh screen 312 is 0, 1, 0, 1, 0, 1, . . . The clock divider corresponding to the seventh screen 312 may set the preset clock signal when the second count value is equal to 0 to a low level, and set the preset clock signal when the second count value is equal to 1 to a high level, to obtain the divided clock signal (i.e., CLK_DIV_2) corresponding to the seventh screen 312. The first enable signal corresponding to the seventh screen 312 is GSTV1, and a frequency of the first enable signal is 120 Hz. The logic operation unit corresponding to the seventh screen 312 may perform a NOT operation on the first enable signal corresponding to the seventh screen 312, to obtain the third enable signal corresponding to the seventh screen 312. The logic operation unit corresponding to the seventh screen 312 then performs a NOR operation on the divided clock signal corresponding to the seventh screen 312 and the third enable signal corresponding to the seventh screen 312, to obtain the second enable signal (i.e., GSTV1_1) corresponding to the seventh screen 312.

Therefore, a frequency of the second enable signal corresponding to the seventh screen 312 may be 60 Hz, the second enable signal corresponding to the seventh screen 312 is a valid signal when being at a high level, and the second enable signal corresponding to the seventh screen 312 is an invalid signal when being at a low level. After the second enable signal corresponding to the seventh screen 312 is processed by using the analog circuit module, the fourth enable signal (i.e., GSTV1_P) corresponding to the seventh screen 312 may be obtained, the fourth enable signal corresponding to the seventh screen 312 is the input signal of the first-level GOA unit corresponding to the seventh screen 312, and the frequency of the fourth enable signal corresponding to the seventh screen 312 is also 60 Hz. The fourth enable signal corresponding to the seventh screen 312 is also a valid signal when being at a high level, and an output signal after the fourth enable signal passes through the GOA unit is also a valid signal when being at a high level. The data write transistor connected to the GOA unit may be controlled to be turned on. The fourth enable signal corresponding to the seventh screen 312 is an invalid signal when being at a low level, and an output signal after the fourth enable signal passes through the GOA unit is also an invalid signal when being is at a low level. The data write transistor connected to the GOA unit may be controlled to be turned off. In this way, the seventh screen 312 may be driven to perform display at a target refresh rate of 60 Hz.

As shown in FIG. 8, because the clock division parameter corresponding to the eighth screen 313 is 4, the up counter corresponding to the eighth screen 313 sequentially counts the rising edges of the preset clock signal sequentially starting from 0, to obtain the second count value corresponding to the eighth screen 313. The second count value (i.e., Counter3) corresponding to the eighth screen 313 is 0, 1, 2, 3, 0, 1, 2, 3, . . . The clock divider corresponding to the eighth screen 313 may set the preset clock signal when the second count value is equal to 0 to a low level, set the preset clock signal when the second count value is equal to 1 to a high level, set also set the preset clock signal when the second count value is equal to 2 to a high level, and set also set the preset clock signal when the second count value is equal to 3 to a high level, to obtain the divided clock signal (i.e., CLK_DIV_4) corresponding to the eighth screen 313. The first enable signal corresponding to the eighth screen 313 is GSTV2, and a frequency of the first enable signal is 120 Hz. The logic operation unit corresponding to the eighth screen 313 may perform a NOT operation on the first enable signal corresponding to the eighth screen 313, to obtain the third enable signal corresponding to the eighth screen 313. The logic operation unit corresponding to the eighth screen 313 then performs a NOR operation on the divided clock signal corresponding to the eighth screen 313 and the third enable signal corresponding to the eighth screen 313, to obtain the second enable signal (i.e., GSTV2_2) corresponding to the eighth screen 313.

Therefore, a frequency of the second enable signal corresponding to the eighth screen 313 may be 30 Hz, the second enable signal corresponding to the eighth screen 313 is a valid signal when being at a high level, and the second enable signal corresponding to the eighth screen 313 is an invalid signal when being at a low level. After the second enable signal corresponding to the eighth screen 313 is processed by using the analog circuit module, the fourth enable signal (i.e., GSTV2_P) corresponding to the eighth screen 313 may be obtained, the fourth enable signal corresponding to the eighth screen 313 is the input signal of the first-level GOA unit corresponding to the eighth screen 313, and the frequency of the fourth enable signal corresponding to the eighth screen 313 is also 30 Hz. The fourth enable signal corresponding to the eighth screen 313 is also a valid signal when being at a high level, and an output signal after the fourth enable signal passes through the GOA unit is also a valid signal when being at a high level. The data write transistor connected to the GOA unit may be controlled to be turned on. The fourth enable signal corresponding to the eighth screen 313 is an invalid signal when being at a low level, and an output signal after the fourth enable signal passes through the GOA unit is also an invalid signal when being is at a low level. The data write transistor connected to the GOA unit may be controlled to be turned off. In this way, the eighth screen 313 may be driven to perform display at a target refresh rate of 30 Hz.

As shown in FIG. 8, because the clock division parameter corresponding to the ninth screen 314 is 1, the up counter corresponding to the ninth screen 314 sequentially counts the rising edges of the preset clock signal sequentially starting from 0, to obtain the second count value corresponding to the ninth screen 314. The second count value (i.e., Counter4) corresponding to the ninth screen 314 is 0, 0, 0, 0, . . . The clock divider corresponding to the ninth screen 314 may set the preset clock signal when the second count value is equal to 0 to a low level, to obtain the divided clock signal (i.e., CLK_DIV_1) corresponding to the ninth screen 314. The first enable signal corresponding to the ninth screen 314 is GSTV3, and a frequency of the first enable signal is 120 Hz. The logic operation unit corresponding to the ninth screen 314 may perform a NOT operation on the first enable signal corresponding to the ninth screen 314, to obtain the third enable signal corresponding to the ninth screen 314. The logic operation unit corresponding to the ninth screen 314 then performs a NOR operation on the divided clock signal corresponding to the ninth screen 314 and the third enable signal corresponding to the ninth screen 314, to obtain the second enable signal (i.e., GSTV3_3) corresponding to the ninth screen 314.

Therefore, a frequency of the second enable signal corresponding to the ninth screen 314 may be 120 Hz, the second enable signal corresponding to the ninth screen 314 is a valid signal when being at a high level, and the second enable signal corresponding to the ninth screen 314 is an invalid signal when being at a low level. After the second enable signal corresponding to the ninth screen 314 is processed by using the analog circuit module, the fourth enable signal (i.e., GSTV3_P) corresponding to the ninth screen 314 may be obtained, the fourth enable signal corresponding to the ninth screen 314 is the input signal of the first-level GOA unit corresponding to the ninth screen 314, and the frequency of the fourth enable signal corresponding to the ninth screen 314 is also 120 Hz. The fourth enable signal corresponding to the ninth screen 314 is also a valid signal when being at a high level, and an output signal after the fourth enable signal passes through the GOA unit is also a valid signal when being at a high level. The data write transistor connected to the GOA unit may be controlled to be turned on. The second enable signal corresponding to the ninth screen 314 is an invalid signal when being at a low level, and an output signal after the second enable signal passes through the GOA unit is also an invalid signal when being is at a low level. The data write transistor connected to the GOA unit may be controlled to be turned off. In this way, the ninth screen 314 may be driven to perform display at a target refresh rate of 120 Hz.

It should be noted that, for each display area, the first enable signal shown in FIG. 8 and the first enable signal shown in FIG. 6 are the same.

In a fourth possible implementation, the data write transistor is a P-type transistor. In this case, the clock divider module sets, for each display area, the preset clock signal when the second count value is equal to the first count value to a low level, and sets the preset clock signal when the second count value is not equal to the first count value to a high level, to obtain the divided clock signal. The clock divider module performs an OR operation on the divided clock signal corresponding to each display area and the corresponding first enable signal, to obtain the second enable signal corresponding to each display area.

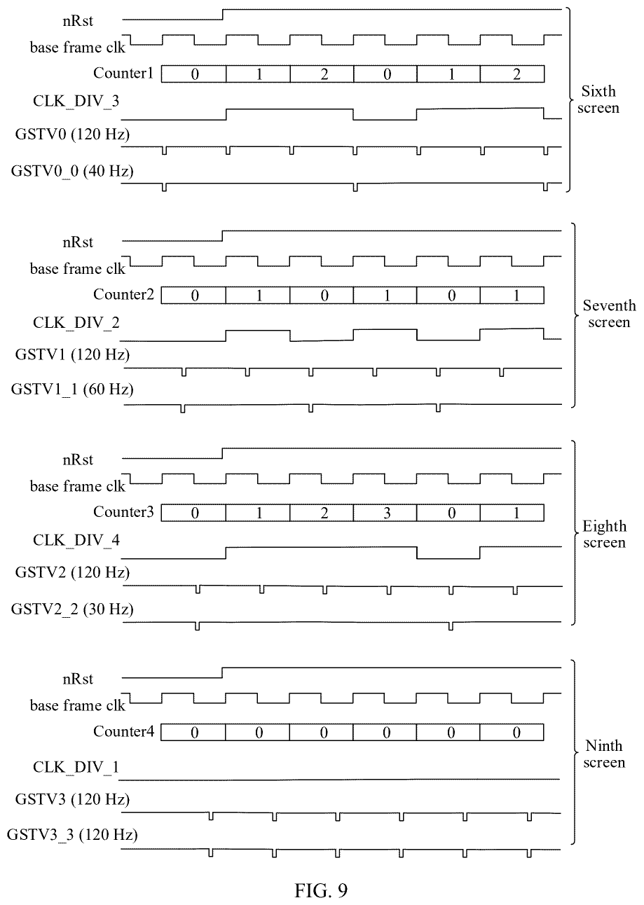

An example in which the first count value is 0 and the third electronic device 300 shown in FIG. 3 includes four display areas, namely, the sixth screen 311, the seventh screen 312, the eighth screen 313, and the ninth screen 314 is used. As shown in FIG. 9, the timing generation module in the timing controller respectively provides a preset clock signal (i.e., base frame clk) and a reset signal (i.e., nRst) to the up counter corresponding to the sixth screen 311, the up counter corresponding to the seventh screen 312, the up counter corresponding to the eighth screen 313, and the up counter corresponding to the ninth screen 314.

As shown in FIG. 9, because the clock division parameter corresponding to the sixth screen 311 is 3, the up counter corresponding to the sixth screen 311 sequentially counts the rising edges of the preset clock signal sequentially starting from 0, to obtain the second count value corresponding to the sixth screen 311. The second count value (i.e., Counter1) corresponding to the sixth screen 311 is 0, 1, 2, 0, 1, 2, . . . The clock divider corresponding to the sixth screen 311 may set the preset clock signal when the second count value is equal to 0 to a low level, set the preset clock signal when the second count value is equal to 1 to a high level, and also set the preset clock signal when the second count value is equal to 2 to a high level, to obtain the divided clock signal (i.e., CLK_DIV_3) corresponding to the sixth screen 311. The first enable signal corresponding to the sixth screen 311 is GSTV0, and a frequency of the first enable signal is 120 Hz. The logic operation unit corresponding to the sixth screen 311 may perform an OR operation on the divided clock signal corresponding to the sixth screen 311 and the first enable signal corresponding to the sixth screen 311, to obtain the second enable signal (i.e., GSTV0_0) corresponding to the sixth screen 311.

Therefore, a frequency of the second enable signal corresponding to the sixth screen 311 may be 40 Hz, the second enable signal corresponding to the sixth screen 311 is a valid signal when being at a low level, and the second enable signal corresponding to the sixth screen 311 is an invalid signal when being at a high level. After the second enable signal corresponding to the sixth screen 311 is processed by using the analog circuit module, the fourth enable signal (i.e., GSTV0_P) corresponding to the sixth screen 311 may be obtained, the fourth enable signal corresponding to the sixth screen 311 is the input signal of the first-level GOA unit corresponding to the sixth screen 311, and the frequency of the fourth enable signal corresponding to the sixth screen 311 is also 40 Hz. The fourth enable signal corresponding to the sixth screen 311 is also a valid signal when being at a low level, and an output signal after the fourth enable signal passes through the GOA unit is also a valid signal when being at a low level. The data write transistor connected to the GOA unit may be controlled to be turned on. The second enable signal corresponding to the sixth screen 311 is an invalid signal when being at a high level, and an output signal after the second enable signal passes through the GOA unit is also an invalid signal when being is at a high level. The data write transistor connected to the GOA unit may be controlled to be turned off. In this way, the sixth screen 311 may be driven to perform display at a target refresh rate of 40 Hz.

As shown in FIG. 9, because the clock division parameter corresponding to the seventh screen 312 is 2, the up counter corresponding to the seventh screen 312 sequentially counts the rising edges of the preset clock signal sequentially starting from 0, to obtain the second count value corresponding to the seventh screen 312. The second count value (i.e., Counter2) corresponding to the seventh screen 312 is 0, 1, 0, 1, 0, 1, . . . The clock divider corresponding to the seventh screen 312 may set the preset clock signal when the second count value is equal to 0 to a low level, and set the preset clock signal when the second count value is equal to 1 to a high level, to obtain the divided clock signal (i.e., CLK_DIV_2) corresponding to the seventh screen 312. The first enable signal corresponding to the seventh screen 312 is GSTV1, and a frequency of the first enable signal is 120 Hz. The logic operation unit corresponding to the seventh screen 312 may perform an OR operation on the divided clock signal corresponding to the seventh screen 312 and the first enable signal corresponding to the seventh screen 312, to obtain the second enable signal (i.e., GSTV1_1) corresponding to the seventh screen 312.

Therefore, a frequency of the second enable signal corresponding to the seventh screen 312 may be 60 Hz, the second enable signal corresponding to the seventh screen 312 is a valid signal when being at a low level, and the second enable signal corresponding to the seventh screen 312 is an invalid signal when being at a high level. After the second enable signal corresponding to the seventh screen 312 is processed by using the analog circuit module, the fourth enable signal (i.e., GSTV1_P) corresponding to the seventh screen 312 may be obtained, the fourth enable signal corresponding to the seventh screen 312 is the input signal of the first-level GOA unit corresponding to the seventh screen 312, and the frequency of the fourth enable signal corresponding to the seventh screen 312 is also 60 Hz. The fourth enable signal corresponding to the seventh screen 312 is also a valid signal when being at a low level, and an output signal after the fourth enable signal passes through the GOA unit is also a valid signal when being at a low level. The data write transistor connected to the GOA unit may be controlled to be turned on. The fourth enable signal corresponding to the seventh screen 312 is an invalid signal when being at a high level, and an output signal after the fourth enable signal passes through the GOA unit is also an invalid signal when being is at a high level. The data write transistor connected to the GOA unit may be controlled to be turned off. In this way, the seventh screen 312 may be driven to perform display at a target refresh rate of 60 Hz.

As shown in FIG. 9, because the clock division parameter corresponding to the eighth screen 313 is 4, the up counter corresponding to the eighth screen 313 sequentially counts the rising edges of the preset clock signal sequentially starting from 0, to obtain the second count value corresponding to the eighth screen 313. The second count value (i.e., Counter3) corresponding to the eighth screen 313 is 0, 1, 2, 3, 0, 1, 2, 3, . . . The clock divider corresponding to the eighth screen 313 may set the preset clock signal when the second count value is equal to 0 to a low level, set the preset clock signal when the second count value is equal to 1 to a high level, set also set the preset clock signal when the second count value is equal to 2 to a high level, and set also set the preset clock signal when the second count value is equal to 3 to a high level, to obtain the divided clock signal (i.e., CLK_DIV_4) corresponding to the eighth screen 313. The first enable signal corresponding to the eighth screen 313 is GSTV2, and a frequency of the first enable signal is 120 Hz. The logic operation unit corresponding to the eighth screen 313 may perform an OR operation on the divided clock signal corresponding to the eighth screen 313 and the first enable signal corresponding to the eighth screen 313, to obtain the second enable signal (i.e., GSTV2_2) corresponding to the eighth screen 313.

Therefore, a frequency of the second enable signal corresponding to the eighth screen 313 may be 30 Hz, the second enable signal corresponding to the eighth screen 313 is a valid signal when being at a low level, and the second enable signal corresponding to the eighth screen 313 is an invalid signal when being at a high level. After the second enable signal corresponding to the eighth screen 313 is processed by using the analog circuit module, the fourth enable signal (i.e., GSTV2_P) corresponding to the eighth screen 313 may be obtained, the fourth enable signal corresponding to the eighth screen 313 is the input signal of the first-level GOA unit corresponding to the eighth screen 313, and the frequency of the fourth enable signal corresponding to the eighth screen 313 is also 30 Hz. The fourth enable signal corresponding to the eighth screen 313 is also a valid signal when being at a low level, and an output signal after the fourth enable signal passes through the GOA unit is also a valid signal when being at a low level. The data write transistor connected to the GOA unit may be controlled to be turned on. The fourth enable signal corresponding to the eighth screen 313 is an invalid signal when being at a high level, and an output signal after the fourth enable signal passes through the GOA unit is also an invalid signal when being is at a high level. The data write transistor connected to the GOA unit may be controlled to be turned off. In this way, the eighth screen 313 may be driven to perform display at a target refresh rate of 30 Hz.

As shown in FIG. 9, because the clock division parameter corresponding to the ninth screen 314 is 1, the up counter corresponding to the ninth screen 314 sequentially counts the rising edges of the preset clock signal sequentially starting from 0, to obtain the second count value corresponding to the ninth screen 314. The second count value (i.e., Counter4) corresponding to the ninth screen 314 is 0, 0, 0, 0, . . . The clock divider corresponding to the ninth screen 314 may set the preset clock signal when the second count value is equal to 0 to a low level, to obtain the divided clock signal (i.e., CLK_DIV_1) corresponding to the ninth screen 314. The first enable signal corresponding to the ninth screen 314 is GSTV3, and a frequency of the first enable signal is 120 Hz. The logic operation unit corresponding to the ninth screen 314 may perform an OR operation on the divided clock signal corresponding to the ninth screen 314 and the first enable signal corresponding to the ninth screen 314, to obtain the second enable signal (i.e., GSTV3_3) corresponding to the ninth screen 314.

Therefore, a frequency of the second enable signal corresponding to the ninth screen 314 may be 120 Hz, the second enable signal corresponding to the ninth screen 314 is a valid signal when being at a low level, and the second enable signal corresponding to the ninth screen 314 is an invalid signal when being at a high level. After the second enable signal corresponding to the ninth screen 314 is processed by using the analog circuit module, the fourth enable signal (i.e., GSTV3_P) corresponding to the ninth screen 314 may be obtained, the fourth enable signal corresponding to the ninth screen 314 is the input signal of the first-level GOA unit corresponding to the ninth screen 314, and the frequency of the fourth enable signal corresponding to the ninth screen 314 is also 120 Hz. The fourth enable signal corresponding to the ninth screen 314 is also a valid signal when being at a low level, and an output signal after the fourth enable signal passes through the GOA unit is also a valid signal when being at a low level. The data write transistor connected to the GOA unit may be controlled to be turned on. The second enable signal corresponding to the ninth screen 314 is an invalid signal when being at a high level, and an output signal after the second enable signal passes through the GOA unit is also an invalid signal when being is at a high level. The data write transistor connected to the GOA unit may be controlled to be turned off. In this way, the ninth screen 314 may be driven to perform display at a target refresh rate of 120 Hz.

It should be noted that, for each display area, the first enable signal shown in FIG. 9 and the first enable signal shown in FIG. 6 are phase-inverted signals, and the GOA control module may select to output the first enable signal shown in FIG. 9 or the first enable signal shown in FIG. 6 according to an actual case.

In summary, through the four optional implementations shown in FIG. 6 to FIG. 9, the second enable signal corresponding to each display area may be generated, and frequencies of the second enable signals corresponding to at least some of the display areas are different. Correspondingly, after the analog circuit module then converts the second enable signal into the fourth enable signal, frequencies of fourth enable signals corresponding to at least some of the display areas are also different, to drive different display areas to perform display at different target refresh rates.

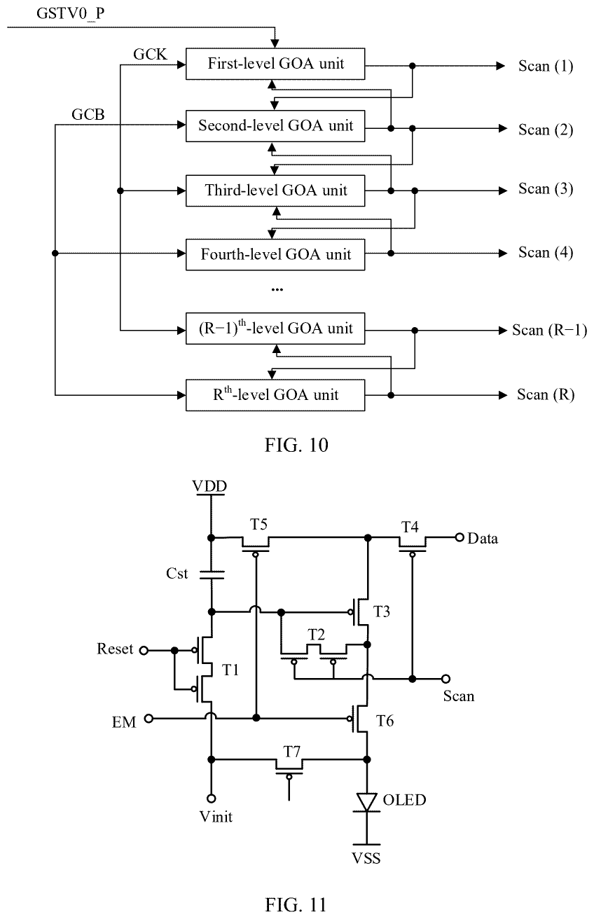

To reflect more clearly how the fourth enable signal corresponding to each display area is inputted into the display, detailed descriptions are provided below with reference to the plurality of cascaded GOA units shown in FIG. 10 and the pixel driver circuit shown in FIG. 11.

In some embodiments, the display includes a GOA circuit corresponding to each display area, each GOA circuit includes a plurality of levels of cascaded GOA units. The sixth screen 311 in the third electronic device 300 is used as an example. As shown in FIG. 10, the GOA circuit of the sixth screen 311 includes R levels of cascaded GOA units, which are respectively a first-level GOA unit, a second-level GOA unit, . . . , and an R^{th}-level GOA unit, where R is an integer greater than 1.

The fourth enable signal (i.e., GSTV0_P) corresponding to the sixth screen 311 is the input signal of the first-level GOA unit corresponding to the sixth screen 311, and is configured for triggering the first-level GOA unit to start to work. In addition, the GOA circuit corresponding to the sixth screen 311 further includes two phase-inverted clock signals with the same frequency, which are respectively GCK and GCB. GCK may provide a clock signal for a GOA unit of an odd-numbered level, and GCB may provide a clock signal for a GOA unit of an even-numbered level.

In some embodiments, a plurality of rows of pixel driver circuits are disposed in each display area. As shown in FIG. 11, each pixel driver circuit in each row of pixel driver circuits includes a first reset transistor T1, a compensation transistor T2, a driver transistor T3, a data write transistor T4, a first light-emitting control transistor T5, a second light-emitting control transistor T6, a second reset transistor T7, a storage capacitor Cst, and a light-emitting device OLED.

The output terminal of the GOA unit of each level is connected to a gate of each data write transistor T4 in a same row of pixel driver circuits, and the output signal of the GOA unit of each level is configured for controlling turn-on/turn-off of the data write transistor T4 connected to the GOA unit. For example, the output terminal of the first-level GOA unit is a scan signal terminal Scan (1) of the first row of pixel driver circuits, and is connected to the gate of each data write transistor T4 in the first row of pixel driver circuits. The output terminal of the second-level GOA unit is a scan signal terminal Scan (2) of the second row of pixel driver circuits, and is connected to the gate of each data write transistor T4 in the second row of pixel driver circuits. By analogy, the output terminal of the R^{th}-level GOA unit is a scan signal terminal Scan (R) of the R^{th} row of pixel driver circuits, and is connected to the gate of each data write transistor T4 in the R^{th} row of pixel driver circuits.

In addition, the output signal of a (K-1)th-level GOA unit is further used as the input signal of a K^{th}-level GOA unit, where K is an integer greater than 1. For example, the output signal of the first-level GOA unit is further used as the input signal of the second-level GOA unit, the output signal of the second-level GOA unit is further used as the input signal of the third-level GOA unit, and by analogy, the output signal of the (R-1)th-level GOA unit is further used as the input signal of the R^{th}-level GOA unit.

In addition, the output signal of the K^{th}-level GOA unit is further used as the reset signal of the (K-1)th-level GOA unit, and is configured for resetting the output signal of the (K-1)^{th}-level GOA unit. For example, the output signal of the second-level GOA unit is further used as the reset signal of the first-level GOA unit, the output signal of the third-level GOA unit is further used as the reset signal of the second-level GOA unit, and by analogy, the output signal of the R^{th}-level GOA unit is further used as the reset signal of the (R-1)^{th}-level GOA unit.

As shown in FIG. 11, a gate of the first reset transistor T1 is connected to a reset signal terminal Reset, a first electrode of the first reset transistor T1 is connected to an initialization signal terminal Vinit, and a second electrode of the first reset transistor T1 is connected to a gate of the driver transistor T3. The first reset transistor T1 is configured to be turned on when a gate reset signal inputted at the reset signal terminal Reset is a valid signal, to reset the gate of the driver transistor T3.

A gate of the compensation transistor T2 is connected to a scan signal terminal Scan, a first electrode of the compensation transistor T2 is connected to a second electrode of the driver transistor T3, and a second electrode of the compensation transistor T2 is connected to the gate of the driver transistor T3. The compensation transistor T2 is configured to be turned on when a scan signal inputted at the scan signal terminal Scan is a valid signal, to compensate for a threshold voltage of the driver transistor T3.

A gate of the data write transistor T4 is connected to the scan signal terminal Scan, a first electrode of the data write transistor T4 is connected to a data signal terminal, and a second electrode of the data write transistor T4 is connected to a first electrode of the driver transistor T3. The data write transistor T4 is configured to be turned on when the scan signal inputted at the scan signal terminal Scan is a valid signal, to write a data voltage corresponding to the display data inputted at the data signal terminal into the first electrode of the driver transistor T3, and further write the data voltage corresponding to the display data into the gate of the driver transistor T3 through the driver transistor T3 and the compensation transistor T2.

A gate of the first light-emitting control transistor T5 is connected to a light-emitting control signal terminal EM, a first electrode of the first light-emitting control transistor T5 is connected to a high-level signal terminal VDD, and a second electrode of the first light-emitting control transistor T5 is connected to the first electrode of the driver transistor T3. A gate of the second light-emitting control transistor T6 is connected to the light-emitting control signal terminal EM, a first electrode of the second light-emitting control transistor T6 is connected to the second electrode of the driver transistor T3, and a second electrode of the second light-emitting control transistor T6 is connected to an anode of the light-emitting device OLED. The first light-emitting control transistor T5 and the second light-emitting control transistor T6 are configured to be turned on when a light-emitting control signal inputted at the light-emitting control signal terminal EM is a valid signal, to drive, through the driver transistor T3, the light-emitting device OLED to emit light.

A first electrode of the second reset transistor T7 is connected to the initialization signal terminal Vinit, and a second electrode of the second reset transistor T7 is connected to the anode of the light-emitting device OLED. In a possible implementation, a gate of the second reset transistor T7 may also be connected to the scan signal terminal Scan, and is configured to be turned on when the scan signal inputted at the scan signal terminal Scan is a valid signal, to reset the anode of the light-emitting device OLED.

A first terminal of the storage capacitor Cst is connected to the high-level signal terminal VDD, and a second terminal of the storage capacitor Cst is connected to the gate of the driver transistor T3. A cathode of the light-emitting device OLED is connected to a low-level signal terminal VSS.

In a possible implementation, the first reset transistor T1, the compensation transistor T2, the driver transistor T3, the data write transistor T4, the first light-emitting control transistor T5, the second light-emitting control transistor T6, and the second reset transistor T7 shown in FIG. 11 are all P-type transistors, each of which is turned on when the gate is at a low level and is turned off when the gate is at a high level.

Certainly, some or all of the first reset transistor T1, the compensation transistor T2, the driver transistor T3, the data write transistor T4, the first light-emitting control transistor T5, the second light-emitting control transistor T6, and the second reset transistor T7 shown in FIG. 11 may be replaced with N-type transistors, each of which is turned on when the gate is at a high level and is turned off when the gate is at a low level.

It should be noted that in embodiments of this application, a source and a drain of each transistor are interchangeable under specific conditions. Therefore, there is no difference in the description of the connection relationship between the source and the drain of each transistor. In embodiments of this application, to distinguish between the source and the drain of the transistor, one of the electrodes is referred to as a first electrode, and the other electrode is referred to as a second electrode.

Therefore, the fourth enable signal corresponding to each display area generated in embodiments of this application is in fact the input signal of the first-level GOA unit corresponding to each display area, and the output signal of the GOA unit of each level is a scan signal inputted at the gate of the data write transistor T4. When the data write transistor T4 is an N-type transistor, the fourth enable signal may be generated by using the foregoing implementation corresponding to FIG. 6 or FIG. 8. When the data write transistor T4 is a P-type transistor, the fourth enable signal may be generated by using the foregoing implementation corresponding to FIG. 7 or FIG. 9.

It may be understood that FIG. 11 is a circuit diagram of a possible pixel driver circuit. The pixel driver circuit in embodiments of this application is not limited to the pixel driver circuit shown in FIG. 11. For example, the pixel driver circuit in embodiments of this application may further include more or fewer devices than those shown in FIG. 11, or connection relationships of the devices shown in FIG. 11 are replaced.

For example, in embodiments of this application, the gate of the compensation transistor T2 and the gate of the data write transistor T4 may not share the same scan signal terminal Scan. An example in which the gate of the data write transistor T4 is connected to a first scan signal terminal, the gate of the compensation transistor T2 is connected to a second scan signal terminal, and the first scan signal terminal and the second scan signal terminal are not a same scan signal terminal is used. Assuming that the data write transistor T4 is an N-type transistor and the compensation transistor T2 is a P-type transistor, the implementation corresponding to the foregoing FIG. 6 or FIG. 8 may be used to generate a fourth enable signal corresponding to the data write transistor T4. After the fourth enable signal corresponding to the data write transistor T4 is processed by a GOA circuit corresponding to the data write transistor T4, a first scan signal corresponding to the data write transistor T4 is generated. In addition, the implementation corresponding to FIG. 7 or FIG. 9 may be used. The fourth enable signal corresponding to the compensation transistor T2 is generated, and after the fourth enable signal corresponding to the compensation transistor T2 is processed by a GOA circuit corresponding to the compensation transistor T2, a second scan signal corresponding to the compensation transistor T2 is generated.

Therefore, in some possible implementations, for an example in which the gate of the data write transistor T4 and the gate of the compensation transistor T2 do not share a same scan signal terminal, one of the data write transistor T4 and the compensation transistor T2 is a P-type transistor, and the other one is an N-type transistor, the electronic device may simultaneously generate the second enable signals shown in FIG. 6 and FIG. 7 or the second enable signals shown in FIG. 8 and FIG. 9, and generate the fourth enable signal corresponding to the data write transistor T4 and the fourth enable signal corresponding to the compensation transistor T2 after processing by the analog circuit module.

The foregoing FIG. 5 to FIG. 9 correspondingly describe an implementation of the second enable signal corresponding to each display area when the display includes four display areas. It may be understood that the display in embodiments of this application may further include another quantity of display areas, for example, two display areas or three display areas. A display including at least a display area is applicable to embodiments of this application. For an implementation of the second enable signal corresponding to the display area, refer to implementations corresponding to FIG. 5 to FIG. 9.

For example, embodiments of this application may further provide a display driver chip. A specific structure of the display driver chip may be shown in FIG. 4. The display driver chip is connected to a display. The display driver chip includes a timing controller. The display includes at least two display areas. The timing controller is configured to: generate a divided clock signal corresponding to each display area based on a preset clock signal and a clock division parameter corresponding to each display area; and generating a second enable signal corresponding to each display area based on the divided clock signal corresponding to each display area and a corresponding first enable signal, where The second enable signal corresponding to each display area is configured for driving the display area corresponding to the second enable signal to perform display at a target refresh rate. Frequencies of the second enable signals corresponding to at least some of the display areas are different, and the target refresh rates corresponding to at least some of the display areas are also different.

In a possible implementation, the timing controller includes a clock divider module. The clock divider module is configured to: sequentially count rising edges of the preset clock signal starting from a first count value to obtain a second count value corresponding to each display area; and generate the divided clock signal corresponding to each display area based on the second count value corresponding to each display area and the preset clock signal. When a difference between the second count value corresponding to each display area and the first count value is equal to the clock division parameter corresponding to the display area, the clock divider module starts to count again from the first count value. In addition, when the reset signal in the timing controller is at a falling edge, the clock divider module starts to count again from the first count value. The clock division parameter is a positive integer.

In a possible implementation, the clock divider module is further configured to: set, for each display area, the preset clock signal when the second count value is equal to the first count value to a high level, and set the preset clock signal when the second count value is not equal to the first count value to a low level, to obtain the divided clock signal.

In a possible implementation, the clock divider module is further configured to: set, for each display area, the preset clock signal when the second count value is equal to the first count value to a low level, and set the preset clock signal when the second count value is not equal to the first count value to a high level, to obtain the divided clock signal.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is an N-type transistor. The clock divider module is further configured to: perform an AND operation on the divided clock signal corresponding to each display area and the corresponding first enable signal, to obtain the second enable signal corresponding to each display area.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is a P-type transistor. The clock divider module is further configured to: perform a NOT operation on the first enable signal corresponding to each display area, to obtain a third enable signal corresponding to each display area; and perform a NAND operation on the divided clock signal corresponding to each display area and the corresponding third enable signal, to obtain the second enable signal corresponding to each display area.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is an N-type transistor. The clock divider module is further configured to: perform a NOT operation on the first enable signal corresponding to each display area, to obtain a third enable signal corresponding to each display area; and perform a NOR operation on the divided clock signal corresponding to each display area and the corresponding third enable signal, to obtain the second enable signal corresponding to each display area.

In a possible implementation, the second enable signal corresponding to each display area is configured for generating an input signal of a first-level GOA unit corresponding to each display area. An output signal of a GOA unit of each level is configured for controlling turn-on/turn-off of a data write transistor connected to the GOA unit. An output signal of a (K-1)^{th}-level GOA unit is further used as an input signal of a K^{th}-level GOA unit. K is an integer greater than 1. The data write transistor is a P-type transistor. The clock divider module is further configured to: perform an OR operation on the divided clock signal corresponding to each display area and the corresponding first enable signal, to obtain the second enable signal corresponding to each display area.

In a possible implementation, the timing controller further includes a timing generation module. The clock divider module includes a clock divider submodule corresponding to each display area. Each clock divider submodule includes an up counter and a clock divider. The timing generation module is configured to output the preset clock signal and the reset signal to each up counter. The up counter is configured to sequentially count the rising edges of the preset clock signal starting from the first count value, to obtain the second count value. The clock divider is configured to generate the divided clock signal based on the second count value and the preset clock signal. When the difference between the second count value corresponding to each display area and the first count value is equal to the clock division parameter corresponding to the display area, the up counter starts to count again from the first count value. In addition, when the reset signal is at the falling edge, the up counter starts to count again from the first count value.

In a possible implementation, the timing controller further includes a GOA control module. Each clock divider submodule further includes a logic operation unit. The GOA control module is configured to output, to each logic operation unit, the first enable signal corresponding to the logic operation unit. The clock divider is further configured to output the divided clock signal to the logic operation unit corresponding to the clock divider. The logic operation unit is configured to generate the second enable signal based on the divided clock signal and the first enable signal.

In a possible implementation, the display driver chip further includes an analog circuit module. The analog circuit module is configured to convert the second enable signal into a fourth enable signal, to output the fourth enable signal to the display. The fourth enable signal corresponding to each display area is an input signal of a first-level GOA unit corresponding to each display area. The second enable signal is a digital signal. The fourth enable signal is an analog signal. A level of the fourth enable signal is greater than a level of the second enable signal.

In a possible implementation, the display driver chip further includes a signal receiving and interpretation module, a core controller, a memory controller, and a frame buffer. The signal receiving and interpretation module is configured to parse a data packet sent by a processor, to obtain display data corresponding to each display area and the target refresh rate corresponding to each display area. The signal receiving and interpretation module is further configured to send the display data corresponding to each display area to the memory controller, and sending the target refresh rate corresponding to each display area to the core controller. The memory controller is configured to store the display data corresponding to each display area in the frame buffer. The core controller is configured to send the target refresh rate corresponding to each display area to the timing controller. The timing controller is configured to generate the clock division parameter corresponding to each display area based on the target refresh rate corresponding to each display area.

In a possible implementation, the display is a foldable screen or a non-foldable screen.

For a detailed process in which the display driver chip implements the method for setting a refresh rate, refer to descriptions corresponding to FIG. 5 to FIG. 11, and details are not described herein again in embodiments of this application.

In addition, embodiments of this application further provide an electronic device. The electronic device may include a processor 410, a display, and the foregoing display driver chip 320. The processor 410 is connected to the display driver chip 320. The display driver chip 320 is further connected to the display.

The electronic device in embodiments of this application may be the first electronic device 100 shown in FIG. 1, and the display included in the electronic device may be the first display 110 shown in FIG. 1. The electronic device in embodiments of this application may alternatively be the second electronic device 200 shown in FIG. 2, and the display included in the electronic device may be the second display 210 shown in FIG. 2. The electronic device in embodiments of this application may alternatively be the third electronic device 300 shown in FIG. 3, and the display included in the electronic device may be the third display 310 shown in FIG. 3.

It may be understood that in addition to the processor 410, the display, and the foregoing display driver chip 320, the electronic device in embodiments of this application may further include other components such as a camera, a memory, a sensor, a mobile communication module, a wireless communication module, and a power supply module. Details are not described herein again.

Embodiments of this application are described with reference to flowcharts and/or block diagrams of the method and the device (system) according to embodiments of this application. It should be understood that computer program instructions may be used to implement each flow and/or each block in the flowcharts and/or the block diagrams and a combination of a flow and/or a block in the flowcharts and/or the block diagrams. These computer program instructions may be provided for a general-purpose computer, a special-purpose computer, an embedded processor, or a processing unit of any other programmable data processing device to generate a machine, so that the instructions executed by the computer or the processing unit of any other programmable data processing device generate an apparatus for implementing a specific function in one or more procedures in the flowcharts and/or in one or more blocks in the block diagrams.

The objectives, technical solutions, and beneficial effects of this application are further described in detail in the foregoing specific implementations. It should be understood that the foregoing descriptions are merely specific implementations of this application, but are not intended to limit the protection scope of this application. Any modification, equivalent replacement, improvement, or the like made based on the technical solutions of this application shall fall within the protection scope of this application.

What is claimed is:

1. A method for setting a refresh rate, applied to a display driver chip, wherein the display driver chip is connected to a display, the display driver chip comprises a timing controller, and the display comprises at least two display areas; and the method comprises:
generating, by the timing controller, a divided clock signal corresponding to each display area based on a preset clock signal and a clock division parameter corresponding to each display area; and
generating, by the timing controller, a second enable signal corresponding to each display area based on the divided clock signal corresponding to each display area and a corresponding first enable signal, wherein
the second enable signal corresponding to each display area is configured for driving the display area corresponding to the second enable signal to perform display at a target refresh rate; and frequencies of the second enable signals corresponding to at least some of the display areas are different, and the target refresh rates corresponding to at least some of the display areas are also different.

2. The method according to claim 1, wherein the timing controller comprises a clock divider module; and the generating, by the timing controller, a divided clock signal corresponding to each display area based on a preset clock signal and a clock division parameter corresponding to each display area comprises:
sequentially counting, by the clock divider module, rising edges of the preset clock signal starting from a first count value to obtain a second count value corresponding to each display area; and
generating, by the clock divider module, the divided clock signal corresponding to each display area based on the second count value corresponding to each display area and the preset clock signal, wherein
when a difference between the second count value corresponding to each display area and the first count value is equal to the clock division parameter corresponding to the display area, the clock divider module starts to count again from the first count value; in addition, when a reset signal in the timing controller is at a falling edge, the clock divider module starts to count again from the first count value; and the clock division parameter is a positive integer.

3. The method according to claim 2, wherein the generating, by the clock divider module, the divided clock signal corresponding to each display area based on the second count value corresponding to each display area and the preset clock signal comprises:
setting, by the clock divider module for each display area, the preset clock signal when the second count value is equal to the first count value to a high level, and setting the preset clock signal when the second count value is not equal to the first count value to a low level, to obtain the divided clock signal.

4. The method according to claim 2, wherein the generating, by the clock divider module, the divided clock signal corresponding to each display area based on the second count value corresponding to each display area and the preset clock signal comprises:
setting, by the clock divider module for each display area, the preset clock signal when the second count value is equal to the first count value to a low level, and setting the preset clock signal when the second count value is not equal to the first count value to a high level, to obtain the divided clock signal.

5. The method according to claim 3, wherein the second enable signal corresponding to each display area is configured for generating an input signal of a first-level GOA unit corresponding to each display area, an output signal of a GOA unit of each level is configured for controlling turn-on/turn-off of a data write transistor connected to the GOA unit, and an output signal of a (K-1)^{th}-level GOA unit is further used as an input signal of a K^{th}-level GOA unit, wherein K is an integer greater than 1, and the data write transistor is an N-type transistor; and the generating, by the timing controller, a second enable signal corresponding to each display area based on the divided clock signal corresponding to each display area and a corresponding first enable signal comprises:
performing, by the clock divider module, an AND operation on the divided clock signal corresponding to each display area and the corresponding first enable signal, to obtain the second enable signal corresponding to each display area.

6. The method according to claim 3, wherein the second enable signal corresponding to each display area is configured for generating an input signal of a first-level GOA unit corresponding to each display area, an output signal of a GOA unit of each level is configured for controlling turn-on/turn-off of a data write transistor connected to the GOA unit, and an output signal of a (K-1)^{th}-level GOA unit is further used as an input signal of a K^{th}-level GOA unit, wherein K is an integer greater than 1, and the data write transistor is a P-type transistor; and the generating, by the timing controller, a second enable signal corresponding to each display area based on the divided clock signal corresponding to each display area and a corresponding first enable signal comprises:
performing, by the clock divider module, a NOT operation on the first enable signal corresponding to each display area, to obtain a third enable signal corresponding to each display area; and
performing, by the clock divider module, a NAND operation on the divided clock signal corresponding to each display area and the corresponding third enable signal, to obtain the second enable signal corresponding to each display area.

7. The method according to claim 4, wherein the second enable signal corresponding to each display area is configured for generating an input signal of a first-level GOA unit corresponding to each display area, an output signal of a GOA unit of each level is configured for controlling turn-on/turn-off of a data write transistor connected to the GOA unit, and an output signal of a (K-1)^{th}-level GOA unit is further used as an input signal of a K^{th}-level GOA unit, wherein K is an integer greater than 1, and the data write transistor is an N-type transistor; and the generating, by the timing controller, a second enable signal corresponding to each display area based on the divided clock signal corresponding to each display area and a corresponding first enable signal comprises:
performing, by the clock divider module, a NOT operation on the first enable signal corresponding to each display area, to obtain a third enable signal corresponding to each display area; and
performing, by the clock divider module, a NOR operation on the divided clock signal corresponding to each display area and the corresponding third enable signal, to obtain the second enable signal corresponding to each display area.

8. The method according to claim 4, wherein the second enable signal corresponding to each display area is configured for generating an input signal of a first-level GOA unit corresponding to each display area, an output signal of a GOA unit of each level is configured for controlling turn-on/turn-off of a data write transistor connected to the GOA unit, and an output signal of a (K-1)^{th}-level GOA unit is further used as an input signal of a K^{th}-level GOA unit, wherein K is an integer greater than 1, and the data write transistor is a P-type transistor; and the generating, by the timing controller, a second enable signal corresponding to each display area based on the divided clock signal corresponding to each display area and a corresponding first enable signal comprises:
performing, by the clock divider module, an OR operation on the divided clock signal corresponding to each display area and the corresponding first enable signal, to obtain the second enable signal corresponding to each display area.

9. The method according to claim 2, wherein the timing controller further comprises a timing generation module, the clock divider module comprises a clock divider submodule corresponding to each display area, and each clock divider submodule comprises an up counter and a clock divider; before the sequentially counting, by the clock divider module, rising edges of the preset clock signal starting from a first count value to obtain a second count value corresponding to each display area, the method further comprises:
the timing generation module outputs the preset clock signal and the reset signal to each up counter;
the sequentially counting, by the clock divider module, rising edges of the preset clock signal starting from a first count value to obtain a second count value corresponding to each display area comprises:
sequentially counting, by the up counter, the rising edges of the preset clock signal starting from the first count value, to obtain the second count value; and
the generating, by the clock divider module, the divided clock signal corresponding to each display area based on the second count value corresponding to each display area and the preset clock signal comprises:
generating, by the clock divider, the divided clock signal based on the second count value and the preset clock signal, wherein
when the difference between the second count value corresponding to each display area and the first count value is equal to the clock division parameter corresponding to the display area, the up counter starts to count again from the first count value; and in addition, when the reset signal is at the falling edge, the up counter starts to count again from the first count value.

10. The method according to claim 9, wherein the timing controller further comprises a GOA control module, and each clock divider submodule further comprises a logic operation unit; before the generating, by the timing controller, a second enable signal corresponding to each display area based on the divided clock signal corresponding to each display area and a corresponding first enable signal, the method further comprises:
outputting, by the GOA control module to each logic operation unit, the first enable signal corresponding to the logic operation unit; and
outputting, by the clock divider, the divided clock signal to the logic operation unit corresponding to the clock divider; and
the generating, by the timing controller, a second enable signal corresponding to each display area based on the divided clock signal corresponding to each display area and a corresponding first enable signal comprises:
generating, by the logic operation unit, the second enable signal based on the divided clock signal and the first enable signal.

11. The method according to claim 1, wherein the display driver chip further comprises an analog circuit module; and after the generating, by the timing controller, a second enable signal corresponding to each display area based on the divided clock signal corresponding to each display area and a corresponding first enable signal, the method further comprises:
converting, by the analog circuit module, the second enable signal into a fourth enable signal, to output the fourth enable signal to the display, wherein
the fourth enable signal corresponding to each display area is an input signal of a first-level GOA unit corresponding to each display area; and the second enable signal is a digital signal, the fourth enable signal is an analog signal, and a level of the fourth enable signal is greater than a level of the second enable signal.

12. The method according to claim 1, wherein the display driver chip further comprises a signal receiving and interpretation module, a core controller, a memory controller, and a frame buffer; and before the generating, by the timing controller, a divided clock signal corresponding to each display area based on a preset clock signal and a clock division parameter corresponding to each display area, the method further comprises:
parsing, by the signal receiving and interpretation module, a data packet sent by a processor, to obtain display data corresponding to each display area and the target refresh rate corresponding to each display area;
sending, by the signal receiving and interpretation module, the display data corresponding to each display area to the memory controller, and sending the target refresh rate corresponding to each display area to the core controller;
storing, by the memory controller, the display data corresponding to each display area in the frame buffer;
sending, by the core controller, the target refresh rate corresponding to each display area to the timing controller; and
generating, by the timing controller, the clock division parameter corresponding to each display area based on the target refresh rate corresponding to each display area.

13. A display driver chip, wherein the display driver chip is connected to a display, the display driver chip comprises a timing controller, and the display comprises at least two display areas; and the timing controller is configured to:
generate a divided clock signal corresponding to each display area based on a preset clock signal and a clock division parameter corresponding to each display area; and
generate a second enable signal corresponding to each display area based on the divided clock signal corresponding to each display area and a corresponding first enable signal, wherein
the second enable signal corresponding to each display area is configured for driving the display area corresponding to the second enable signal to perform display at a target refresh rate; and frequencies of the second enable signals corresponding to at least some of the display areas are different, and the target refresh rates corresponding to at least some of the display areas are also different.

14. The display driver chip according to claim 13, wherein the timing controller comprises a clock divider module; and the clock divider module is configured to:
sequentially count rising edges of the preset clock signal starting from a first count value to obtain a second count value corresponding to each display area; and
generate the divided clock signal corresponding to each display area based on the second count value corresponding to each display area and the preset clock signal, wherein
when a difference between the second count value corresponding to each display area and the first count value is equal to the clock division parameter corresponding to the display area, the clock divider module starts to count again from the first count value; in addition, when a reset signal in the timing controller is at a falling edge, the clock divider module starts to count again from the first count value; and the clock division parameter is a positive integer.

15. The display driver chip according to claim 14, wherein the clock divider module is further configured to:
set, for each display area, the preset clock signal when the second count value is equal to the first count value to a high level, and set the preset clock signal when the second count value is not equal to the first count value to a low level, to obtain the divided clock signal.

16. The display driver chip according to claim 15, wherein the second enable signal corresponding to each display area is configured for generating an input signal of a first-level GOA unit corresponding to each display area, an output signal of a GOA unit of each level is configured for controlling turn-on/turn-off of a data write transistor connected to the GOA unit, and an output signal of a (K-1)^{th}-level GOA unit is further used as an input signal of a K^{th}-level GOA unit, wherein K is an integer greater than 1, and the data write transistor is an N-type transistor; and the clock divider module is further configured to:
perform an AND operation on the divided clock signal corresponding to each display area and the corresponding first enable signal, to obtain the second enable signal corresponding to each display area.

17. The display driver chip according to claim 15, wherein the second enable signal corresponding to each display area is configured for generating an input signal of a first-level GOA unit corresponding to each display area, an output signal of a GOA unit of each level is configured for controlling turn-on/turn-off of a data write transistor connected to the GOA unit, and an output signal of a (K-1)^{th}-level GOA unit is further used as an input signal of a K^{th}-level GOA unit, wherein K is an integer greater than 1, and the data write transistor is a P-type transistor; and the clock divider module is further configured to:
perform a NOT operation on the first enable signal corresponding to each display area, to obtain a third enable signal corresponding to each display area; and
perform a NAND operation on the divided clock signal corresponding to each display area and the corresponding third enable signal, to obtain the second enable signal corresponding to each display area.

18. The display driver chip according to claim 14, wherein the timing controller further comprises a timing generation module, the clock divider module comprises a clock divider submodule corresponding to each display area, and each clock divider submodule comprises an up counter and a clock divider;
the timing generation module is configured to output the preset clock signal and the reset signal to each up counter;
the up counter is configured to sequentially count the rising edges of the preset clock signal starting from the first count value, to obtain the second count value; and
the clock divider is configured to generate the divided clock signal based on the second count value and the preset clock signal, wherein
when the difference between the second count value corresponding to each display area and the first count value is equal to the clock division parameter corresponding to the display area, the up counter starts to count again from the first count value; and in addition, when the reset signal is at the falling edge, the up counter starts to count again from the first count value.

19. The display driver chip according to claim 18, wherein the timing controller further comprises a GOA control module, and each clock divider submodule further comprises a logic operation unit;
the GOA control module is configured to output, to each logic operation unit, the first enable signal corresponding to the logic operation unit;
the clock divider is further configured to output the divided clock signal to the logic operation unit corresponding to the clock divider; and
the logic operation unit is configured to generate the second enable signal based on the divided clock signal and the first enable signal.

20. An electronic device, comprising:
a processor, a display, and a display driver chip, wherein the processor is connected to the display driver chip, the display driver chip is further connected to the display, the display driver chip comprises a timing controller, the display comprises at least two display areas; and the timing controller is configured to:
generate a divided clock signal corresponding to each display area based on a preset clock signal and a clock division parameter corresponding to each display area; and
generate a second enable signal corresponding to each display area based on the divided clock signal corresponding to each display area and a corresponding first enable signal,
wherein the second enable signal corresponding to each display area is configured for driving the display area corresponding to the second enable signal to perform display at a target refresh rate; and frequencies of the second enable signals corresponding to at least some of the display areas are different, and the target refresh rates corresponding to at least some of the display areas are also different.
